(19) United States
(12) Patent Application Publication
(10) Pub. No.: US 2006/0265135 A1
(43) Pub. Date: Nov. 23, 2006

(54) Bio-information analyzer, bio-information analysis method and bio-information analysis program

(75) Inventors: Yuichi Kumaki, Tokyo (JP); Hiroki Ueda, Kobe (JP)

Correspondence Address: BIRCH STEWART KOLASCH & BIRCH, PO BOX 747, FALLS CHURCH, VA, 22040-0747, US

(73) Assignees: INTEC Web and Genome Informatics, Tokyo (JP); RIKEN, Wako-shi (JP)

(21) Appl. No.: 11/396,508

(22) Filed: Apr. 4, 2006

(30) Foreign Application Priority Data
Mar. 31, 2005 (JP) 2005-103001

(51) Int. Cl. G06F 19/00

(52) U.S. Cl. 702/19; 702/20

(57) ABSTRACT

With the use of a bio-information analyzer, a total contribution showing a relationship between a gene expression regulatory sequence and a biological phenomenon is calculated. This total contribution is calculated based on contributions of a gene expression regulatory sequence to a plurality of gene candidates and contributions of the plurality of gene candidates to a biological phenomenon. By performing calculation of the total contribution for a number of gene expression regulatory sequence candidates, a profile of relationships between the respective gene expression regulatory sequence candidates and biological phenomena can be created. By using the created profile of data, a biological phenomenon-specific gene expression regulatory sequence can be predicted from new and known gene expression regulatory sequences and gene expression regulatory sequence candidates. This enables the search for various gene expression regulatory sequences in a wide variety of living organisms including higher eukaryotes.

### BACKGROUND OF THE INVENTION

1. Field of the Invention

The present invention relates to a bio-information analyzer, a bio-information analysis method and a bio-information analysis program.

2. Background

“Genome network research”, which is being advanced in recent years, is research and development that is aiming at elucidating a genome network, i.e., a molecular network that harmonizes functions of genes and enables a life activity, by doing an exhaustive analysis of expression regulation function of each gene on the genome and interactions between biological molecules such as proteins and constructing it as an integrated database.

Among the techniques for elucidating expression regulation functions of each gene on the genome, e.g., of yeast, there is a technique in which gene expression regulatory sequences specifically relating to given biological phenomena are obtained from a result of comprehensive gene expression analysis by DNA chips etc. In this technique, from obtained analysis results, gene expression regulatory sequences specific for a given biological phenomenon are predicted by an approach in which a group of genes whose mRNA expression specifically changed against the given biological phenomenon are extracted and from upstream regions of the grouped genes on the genome sequence highly homologous sequences are searched.

As related gene expression analysis methods, for example, there are the methods described in the following documents 1 to 5. In the methods described in these documents, sequence candidates for gene expression regulatory factors are searched by analyzing upstream regions of gene sequence candidates in the yeast genome.

Document 1: Brazma, A., Jonassen, I., Vilo, J. and Ukkonen, E., Predicting gene regulatory elements in silico on a genomic scale. Genome Res., 1998, 8, 1202-1215.

Document 2: Hughes, J D., Estep, P W., Tavazoie S., & Church, G M., Computational identification of cis-regulatory elements associated with groups of functionally related genes in Saccharomyces cerevisiae. Journal of Molecular Biology, 2000, 296, 1205-14.

Document 3: Liu, X., Brutlag, D. and Liu, J., Bioprospector: discovering conserved DNA motifs in upstream regulatory regions of coexpressed genes. Pac. Symp. Biocomput., 2001, 127-138.

Document 4: Bussemaker, H., Li, H. and Siggia, E., Regulatory element detection using correlation with expression. Nat. Genet., 2001, 27, 167-171.

Document 5: Segal, E., Yelensky, R. and Koller, D., Genome-wide discovery of transcriptional modules from DNA sequence and gene expression. Bioinformatics, 2003, 19, i273-i282.

However, with the use of the related techniques described in the above documents, significant prediction results have been obtained only for gene expression regulatory sequences that specifically relate to given biological phenomena in lower eukaryotes such as yeast. In other words, in higher eukaryotes including vertebrates, a situation has been continuing in which useful prediction results are difficult to be obtained for gene expression regulatory sequences that specifically relate to given biological phenomena.

One of the reasons for difficulty in obtaining a useful prediction result in a higher eukaryote is, for example, that its gene expression regulation mechanism is complicated in a higher eukaryote. For this reason, in a higher eukaryote, for a group of genes whose gene expression changes specifically for a biological phenomenon in the same manner, there are a plurality of gene expression regulatory sequences that relate to the gene expression regulation. Therefore, in an approach for searching sequences highly homologous each other, it was difficult to predict gene expression regulatory sequences for these genes.

### SUMMARY OF THE INVENTION

The invention has been made in view of the above circumstances, and the object of the invention is to provide a bio-information analysis technique capable of searching various gene expression regulatory sequence candidates in a wide variety of living organisms including higher eukaryotes.

According to the invention, a bio-information analyzer comprising a primary data acquisition unit which acquires primary data including regulatory-side contributions which are contributions of combinations between a gene expression regulatory sequence candidate of an analysis object and each of a plurality of gene sequence candidates; a secondary data acquisition unit which acquires secondary data including phenomenon-side contributions which are contributions of combinations between each of the plurality of gene sequence candidates and a biological phenomenon of an analysis object; a tertiary data generation unit which generates, based on the primary data and the secondary data, tertiary data which includes a total contribution of a combination between the gene expression regulatory sequence candidate and the biological phenomenon through the plurality of gene sequence candidates, which is a sum of individual contributions of a combination between the gene expression regulatory sequence candidate and the biological phenomenon based on the regulatory-side contributions of the primary data and the phenomenon-side contributions of the secondary data corresponding to the respective gene sequence candidates; and an output unit which outputs the tertiary data is provided.

The tertiary data generation unit may be configured so as to generate the tertiary data composed of a tertiary matrix whose matrix elements are contributions of combinations between each of the plurality of gene expression regulatory sequence candidates and each of the plurality of biological phenomena by calculating a product of a primary matrix based on the primary data by a secondary matrix based on the secondary data.

According to the invention, a contribution of a combination between a gene expression regulatory sequence candidate and a biological phenomenon through gene sequence candidates (the tertiary data) can be preferably obtained from contributions of combinations between the gene expression regulatory sequence candidate and gene sequence candidates (the primary data) and contributions of combinations between the gene sequence candidates and the biological phenomenon (the secondary data).

Here, in the invention, a plurality of gene sequence candidates are used. It is considered that each of the plurality of gene sequence candidates is affected by a gene expression regulatory sequence candidate and also affects a biological phenomenon. That is, each gene sequence candidate has a contribution with a gene expression regulatory sequence candidate and also has a contribution with a biological phenomenon of an object. Here, the former is referred to as a regulatory-side contribution and the latter is referred to as a phenomenon-side contribution.

When the regulatory-side contributions and phenomenon-side contributions of a plurality of gene sequence candidates are collected, though their magnitudes are different, it is considered that any contribution contributes to the overall action of a gene expression regulatory sequence candidate and a biological phenomenon. Therefore, in the invention, as described above, by considering individual contributions based on the regulatory-side contributions and phenomenon-side contributions of the respective gene sequence candidates, a total contribution which is a sum of the individual contributions of a plurality of gene sequence candidates is obtained. The total contribution can be easily obtained, for example, by matrix calculation as described below. The total contribution reflects the regulatory-side contributions and phenomenon-side contributions of a plurality of gene sequence candidates, therefore, it has a high reliability as a parameter representing an intensity of a relationship between a gene expression regulatory sequence candidate and a biological phenomenon. In this way, according to the invention, information for prediction with a high reliability for a relationship between a gene expression regulatory sequence candidate and a biological phenomenon can be provided.

Accordingly, it becomes possible to predict also an expression regulatory factor which was difficult to be searched as an expression regulatory factor for a gene related to a given biological phenomenon in related arts.

As described hereafter, other aspects of the invention exist. Thus, this summary of the invention is intended to provide a few aspects of the invention and is not intended to limit the scope of the invention described and claimed herein.

### BRIEF DESCRIPTION OF THE DRAWINGS

The accompanying drawings are incorporated in and constitute a part of this specification. The drawings exemplify certain aspects of the invention and, together with the description, serve to explain some principles of the invention.

FIG. 1 is a functional block diagram showing the overall configuration of a bio-information analysis system according to an embodiment.

FIG. 2 is a functional block diagram showing the internal configuration of a gene expression regulatory sequence/biological phenomenon data generation function of a bio-information analyzer according to an embodiment in detail.

FIGS. 3A to 3C are functional block diagrams showing the internal configuration of each functional block of a bio-information analyzer according to an embodiment in more detail.

FIG. 4 is a data structure diagram schematically showing a mode of creating a profile of a relationship between a gene expression regulatory sequence and a biological phenomenon through a plurality of genes performed by a bio-information analyzer according to an embodiment.

FIG. 5 is a conceptual diagram schematically showing a mode of creating a profile of a relationship between a gene expression regulatory sequence and a biological phenomenon through a plurality of genes performed by a bio-information analyzer according to an embodiment.

FIG. 6 is a flowchart for illustrating an operation performed by a bio-information analyzer according to an embodiment.

FIG. 7 is a functional block diagram illustrating a configuration for generating gene expression regulatory sequence data in a bio-information analysis system according to an embodiment.

FIG. 8 is a schematic diagram for illustrating generation of gene expression regulatory sequence candidate data to be used in a bio-information analysis system according to an embodiment.

FIG. 9 is a flowchart illustrating generation of gene expression regulatory sequence data in a bio-information analysis system according to an embodiment.

FIG. 10 is a functional block diagram showing the configuration of a gene expression regulatory sequence candidate data generation device in a bio-information analysis system according to an embodiment.

FIG. 11 is a flowchart for illustrating generation of gene expression regulatory sequence candidate data to be used in a bio-information analysis system according to an embodiment.

FIG. 12 is a functional block diagram showing the configuration of a transcription start site/gene sequence candidate data generation device in a bio-information analysis system according to an embodiment.

FIG. 13 is a flowchart illustrating generation of transcription start site/gene sequence candidate data in a bio-information analysis system according to an embodiment.

FIG. 14 is a functional block diagram showing the configuration of a gene expression regulatory sequence data generation device in a bio-information analysis system according to an embodiment.

FIG. 15 is a schematic diagram for illustrating setting of a contribution for gene expression regulatory sequence data in a bio-information analysis system according to an embodiment.

FIG. 16 is a flowchart illustrating generation of gene expression regulatory sequence data in a bio-information analysis system according to an embodiment.

FIG. 17 is a functional block diagram showing the configurations of a microarray analyzer and a scanner in a bio-information analysis system according to an embodiment.

FIG. 18 is a data structure diagram for illustrating gene/biological phenomenon data acquired by a microarray analyzer and a scanner in a bio-information analysis system according to an embodiment.

FIG. 19 is a flowchart illustrating generation of gene/biological phenomenon data by a microarray analyzer and a scanner in a bio-information analysis system according to an embodiment.

FIG. 20 is a functional block diagram showing the inner configuration of a significance judgment unit of a bio-information analyzer according to an embodiment.

FIG. 21 is a data structure diagram for illustrating data processing in a significance judgment unit of a bio-information analyzer according to an embodiment.

FIG. 22 shows graphs for illustrating scoring of data in a significance judgment unit of a bio-information analyzer according to an embodiment.

FIG. 23 shows a data structure diagram and a graph for illustrating generation of random data in a significance judgment unit of a bio-information analyzer according to an embodiment.

FIG. 24 is a data structure diagram for illustrating a judgment result in a significance judgment unit of a bio-information analyzer according to an embodiment.

FIG. 25 is a flowchart for illustrating an operation performed by a significance judgment unit of a bio-information analyzer according to an embodiment.

FIG. 26 is a functional block diagram showing the internal configuration of a normalization unit of a bio-information analyzer according to an embodiment in detail.

FIG. 27 is a schematic diagram for illustrating a mode of normalization performed by a normalization unit of a bio-information analyzer according to an embodiment.

FIG. 28 is a data structure diagram for illustrating a mode of normalization performed by a normalization unit of a bio-information analyzer according to an embodiment.

FIG. 29 is a data structure diagram for illustrating a mode of normalization performed by a normalization unit of a bio-information analyzer according to an embodiment.

FIG. 30 is a data structure diagram for illustrating a mode of normalization performed by a normalization unit of a bio-information analyzer according to an embodiment.

FIG. 31 shows graphs for illustrating a mode of normalization performed by a normalization unit of a bio-information analyzer according to an embodiment.

FIG. 32 is a data structure diagram for illustrating a mode of normalization performed by a normalization unit of a bio-information analyzer according to an embodiment.

FIG. 33 is a data structure diagram for illustrating a mode of normalization performed by a normalization unit of a bio-information analyzer according to an embodiment.

FIG. 34 shows graphs for illustrating a mode of normalization performed by a normalization unit of a bio-information analyzer according to an embodiment.

FIG. 35 is a data structure diagram for illustrating a mode of normalization performed by a normalization unit of a bio-information analyzer according to an embodiment.

FIG. 36 is a flowchart for illustrating a mode of normalization performed by a normalization unit of a bio-information analyzer according to an embodiment.

FIG. 37 is a flowchart for illustrating an operation performed by a bio-information analysis system according to an embodiment.

FIG. 38 is a data structure diagram for illustrating a method of analyzing a regulation mechanism of a cancer gene according to an embodiment.

FIG. 39 is a data structure diagram for illustrating a method of analyzing a regulation mechanism of a cancer gene according to an embodiment.

FIG. 40 is a data structure diagram for illustrating a method of analyzing a difference in gene regulation for each tissue according to an embodiment.

### DETAILED DESCRIPTION

The following detailed description refers to the accompanying drawings. Although the description includes exemplary implementations, other implementations are possible and changes may be made to the implementations described without departing from the spirit and scope of the invention. The following detailed description and the accompanying drawings do not limit the invention. Instead, the scope of the invention is defined by the appended claims.

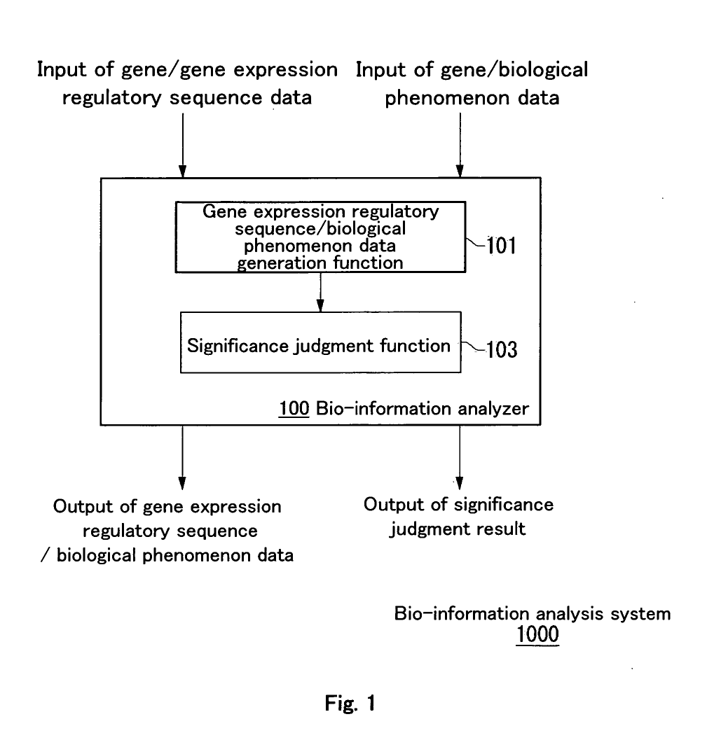

FIG. 1 is a functional block diagram showing the overall configuration of a bio-information analysis system according to an embodiment. In FIG. 1, only the outline of the configuration of a bio-information analysis system 1000 is shown and a detailed internal configuration thereof will be explained using other drawings described later.

The bio-information analysis system 1000 is a bio-information analysis system capable of predicting a gene expression regulatory sequence specific for a body tissue, time or a biological phenomenon with a computer using comprehensive gene expression information specific for a body tissue, time or a biological phenomenon obtained by an experimental technique such as DNA chip.

Further, the bio-information analysis system 1000 is used for elucidating a gene expression regulatory sequence of a gene related to a specific biological phenomenon by combining genome-wide gene expression regulatory region data and genome-wide gene expression data (data from DNA chip).

Further, the bio-information analysis system 1000 is used for elucidating a biological system, a gene regulation network, etc. by genome-widely elucidating a gene expression regulatory sequence of a gene related to a specific biological phenomenon.

The bio-information analysis system 1000 is equipped with a bio-information analyzer 100. The bio-information analyzer 100 creates a profile of a relationship between a biological phenomenon and a sequence candidate by using the comprehensive gene expression information in a given biological phenomenon for a given sequence candidate for a known and new gene expression regulatory sequence. The bio-information analyzer 100 elucidates a gene expression regulatory sequence of a gene related to a specific biological phenomenon by the creation of this profile.

The bio-information analyzer 100 has a gene expression regulatory sequence/biological phenomenon data generation function 101 and a significance judgment function 103 as its major functions. Upon receiving input of gene expression regulatory sequence data and gene/biological phenomenon data from outside, the bio-information analyzer 100 generates gene expression regulatory sequence/biological phenomenon data by the gene expression regulatory sequence/biological phenomenon data generation function 101 based on these data. The bio-information analyzer 100 can output the generated gene expression regulatory sequence/biological phenomenon data directly to outside.

Further, the bio-information analyzer 100 judges whether or not there is a significant relationship between a gene expression regulatory sequence and a biological phenomenon by the significance judgment function 103 based on the gene expression regulatory sequence/biological phenomenon data. In addition, the bio-information analyzer 100 outputs the obtained significance judgment result to outside.

Incidentally, the bio-information analyzer 100 is a computer equipped with an operation unit that accepts an operation by a user and this operation unit functions as an input unit. In addition, the bio-information analyzer 100 is equipped with an output unit such as a display or a printer. Further, the bio-information analyzer 100 is equipped with a communication unit to communicate with another device such as a computer or a server via a network or the like. This communication unit also corresponds to the input/output unit of the bio-information analyzer 100.

Hereinafter, an embodiment of the invention will be described in the following order.
1. Generation of gene expression regulatory sequence/biological phenomenon data
2. Generation of gene expression regulatory sequence data
3. Generation of gene/biological phenomenon data
4. Judgment of significance

Here, “1” is the description of the gene expression regulatory sequence/biological phenomenon data generation function 101 in the bio-information analyzer 100 in FIG. 1.

“2” and “3” are the descriptions of the generation of data to be the basis for the above “1” (data to be input to the bio-information analyzer 100).

“4” is the description of the significance judgment function 103 in FIG. 1.

<1. Generation of Gene Expression Regulatory Sequence/Biological Phenomenon Data>

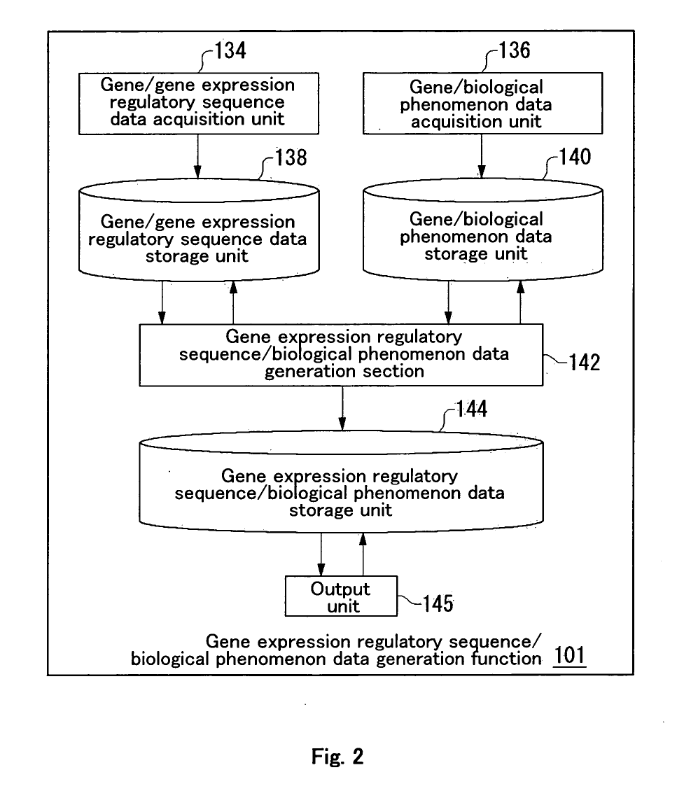

FIG. 2 shows a configuration related to the gene expression regulatory sequence/biological phenomenon data generation function 101 in the bio-information analyzer 100 according to the embodiment. In the bio-information analyzer 100, a gene expression regulatory sequence data acquisition unit 134 corresponds to a primary data acquisition unit and, as the primary data, data of contributions of respective combinations between a plurality of gene expression regulatory sequences and a plurality of genes (gene expression regulatory sequence data) is acquired. Further, the acquired data is stored in a gene/gene expression regulatory sequence data storage unit 138.

Further, a gene/biological phenomenon data acquisition unit 136 corresponds to a secondary data acquisition unit and, as the secondary data, data of contributions of respective combinations between a plurality of genes and a plurality of biological phenomena (gene/biological phenomenon data) is acquired. The acquired data is stored in a gene/biological phenomenon data storage unit 140.

Further, the gene expression regulatory sequence/biological phenomenon data generation function 101 is equipped with a gene expression regulatory sequence/biological phenomenon data generation section 142. This gene expression regulatory sequence/biological phenomenon data generation section 142 acquires gene/gene expression regulatory sequence data and gene/biological phenomenon data from the gene/gene expression regulatory sequence data storage unit 138 and the gene/biological phenomenon data storage unit 140, respectively. Then, the gene expression regulatory sequence/biological phenomenon data generation section 142 generates gene expression regulatory sequence/biological phenomenon data, which corresponds to the tertiary data, from the acquired data. The generated data is stored in a gene expression regulatory sequence/biological phenomenon data storage unit 144 and output from an output unit 145.

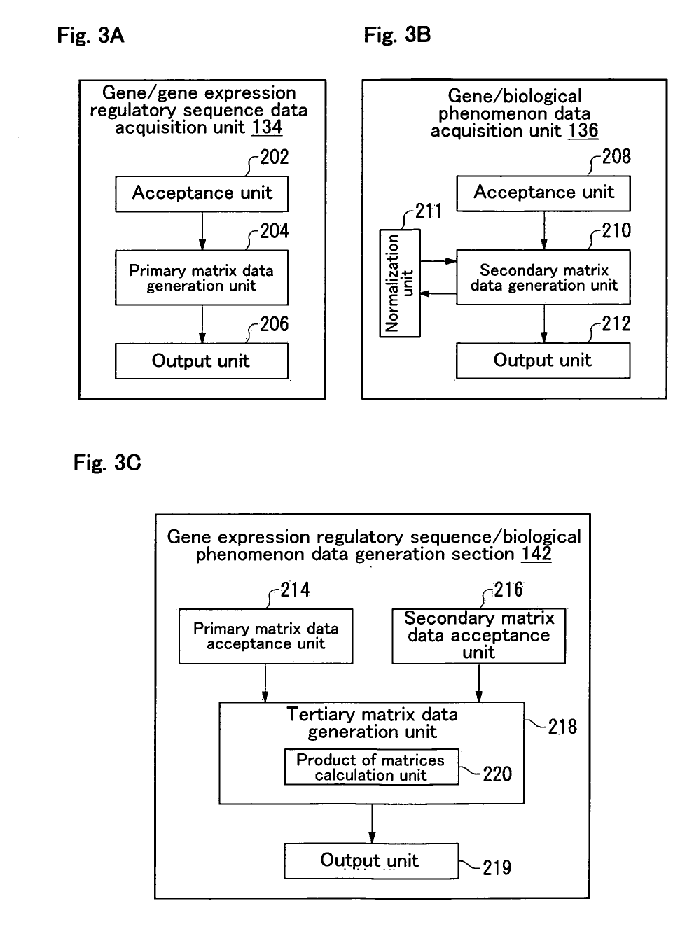

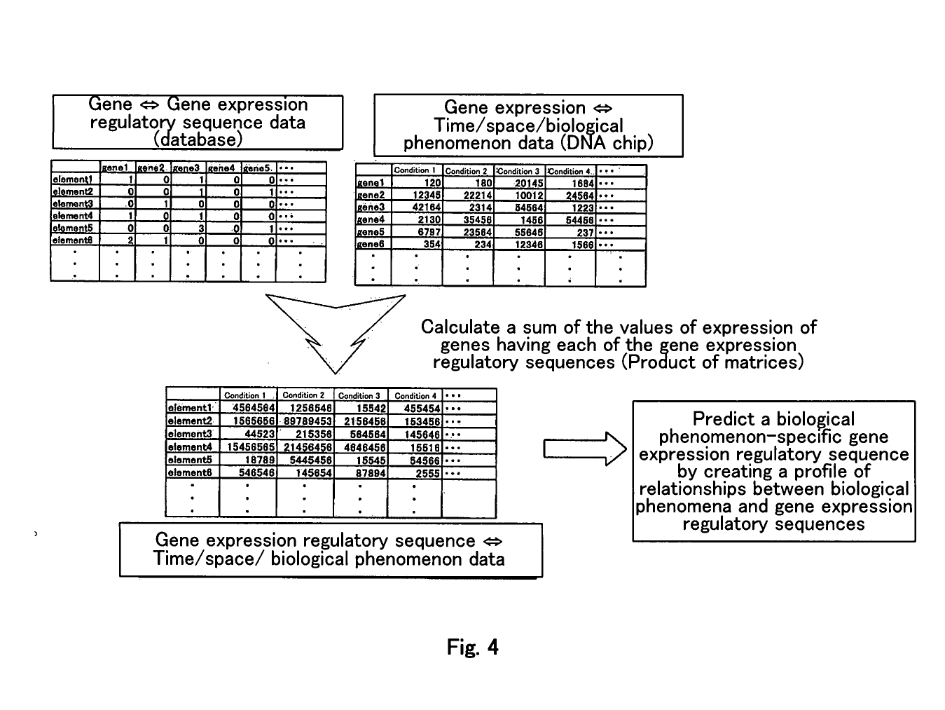

FIGS. 3A to 3C are functional block diagrams showing the internal configuration of each functional block of FIG. 2 in more detail, and FIG. 4 shows a generation process of the gene expression regulatory sequence/biological phenomenon data.

FIG. 3A shows the internal configuration of the gene expression regulatory sequence data acquisition unit 134. The gene expression regulatory sequence data acquisition unit 134 is equipped with an acceptance unit 202 that accepts gene expression regulatory sequence data from outside. The gene expression regulatory sequence data accepted by the acceptance unit 202 is sent to a primary matrix data generation unit 204 and transformed to data in a matrix format (primary matrix data). Further, the primary matrix data is stored in a gene expression regulatory sequence data storage unit 138 by an output unit 206.

The above-mentioned primary matrix data is shown in the upper left side of FIG. 4. In the primary matrix data, each matrix element is a contribution of each combination between a gene expression regulatory sequence and a gene. This contribution is a value that is set in accordance with the distance between a gene expression regulatory sequence and a transcription start site upstream of the gene as described later. Incidentally, when the matrix data is accepted by the acceptance unit 202, a transformation process to the matrix data may be omitted.

FIG. 3B shows the internal configuration of the gene/biological phenomenon data acquisition unit 136. The gene/biological phenomenon data acquisition unit 136 is equipped with an acceptance unit 208 that accepts gene/biological phenomenon data from outside. The gene/biological phenomenon data accepted by the acceptance unit 208 is sent to a secondary matrix data generation unit 210 and transformed to data in a matrix format (secondary matrix data). Further, the secondary matrix data is stored in the gene/biological phenomenon data storage unit 140 by an output unit 212.

Incidentally, a normalization unit 211 which will be described later may be connected to the secondary matrix data generation unit 210. In this case, when the generated secondary matrix data includes variation, analysis accuracy can be improved by normalizing the data using the normalization unit 211.

The above-mentioned secondary matrix data is shown in the upper right side of FIG. 4. In the secondary matrix data, each matrix element is a contribution of each combination between a gene and a biological phenomenon. This contribution is a value that is generated from the expression level of the gene. Incidentally, when the matrix data is accepted by the acceptance unit 208, a transformation process to matrix data may be omitted.

FIG. 3C shows the internal configuration of the gene expression regulatory sequence/biological phenomenon data generation section 142. The gene expression regulatory sequence/biological phenomenon data generation section 142 is equipped with a primary matrix data acceptance unit 214 that accepts primary matrix data and a secondary matrix data acceptance unit 216 that accepts secondary matrix data. Based on the primary matrix data and the secondary matrix data accepted in this way, a product of matrices calculation unit 220 of a tertiary matrix data generation unit 218 generates tertiary matrix data. Here, as shown in FIG. 4, the primary matrix data and the secondary matrix data are multiplied. This tertiary matrix data is gene expression regulatory sequence/biological phenomenon data. The generated matrix data is output by an output unit 219.

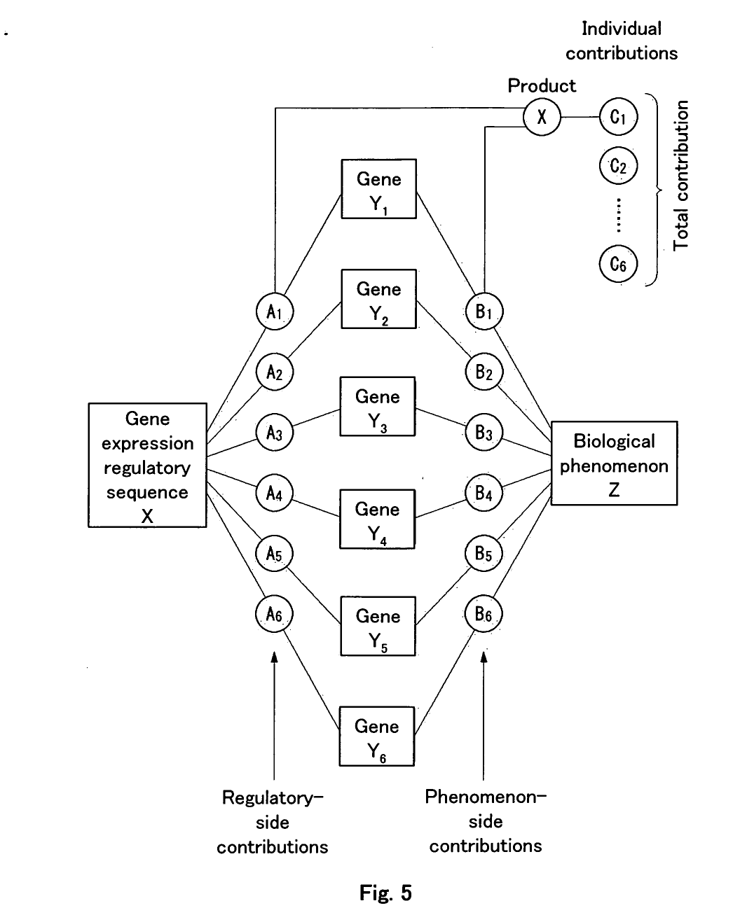

As described above, according to the process shown in FIG. 4, a biological phenomenon-specific gene expression regulatory sequence can be predicted by creating a profile of a relationship between a biological phenomenon and a gene expression regulatory sequence. That is, according to the process, as illustrated by way of FIG. 5 which will be described later, a sum of values of gene expression of all genes having any of the sequences for the respective gene expression regulatory sequence candidates in a certain biological phenomenon can be calculated. Accordingly, the degree of the contribution of the gene expression regulatory sequence candidate to the gene expression in the biological phenomenon can be expressed. By performing such a process for a number of gene expression regulatory sequence candidates, a profile of relationships between the respective gene expression regulatory sequence candidates and gene expression can be created, and as a result, it becomes possible to predict a biological phenomenon-specific gene expression regulatory sequence.

Here, with reference to FIG. 5, the tertiary matrix data obtained by multiplying matrices in FIG. 4, i.e., the gene expression regulatory sequence/biological phenomenon data will be explained.

In FIG. 5, one gene expression regulatory sequence X of an analysis object is positioned in the left side, one biological phenomenon Z is positioned in the right, and a plurality of genes Y1 to Y6 are positioned in the center. In the example of the drawing, only 6 genes are shown for simplifying the explanation.

The one gene expression regulatory sequence X has contributions A1 to A6 with each of the respective plurality of genes Y1 to Y6. In the same way, the one biological phenomenon Z has contributions B1 to B6 with each of the respective plurality of genes Y1 to Y6. Here, the contributions A1 to A6 are referred to as regulatory-side contributions and the contributions B1 to B6 are referred to as phenomenon-side contributions.

Then, the attention is paid to the individual genes which are models in FIG. 5. The gene expression regulatory sequence X has the regulatory-side contribution A1 with the gene Y1, and the gene Y1 has the phenomenon-side contribution B1 with the biological phenomenon Z1. Therefore, it can be said that the gene expression regulatory sequence X is related to the biological phenomenon Z through the gene Y1. Here, the intensity of this relationship is referred to as an individual contribution C1.

The individual contribution C1 can be expressed as a function of the regulatory-side contribution A1 and the phenomenon-side contribution B1. In this embodiment, the individual contribution C1 is a product of the regulatory-side contribution A1 and the phenomenon-side contribution B1. Also for the genes Y2 to Y6, similar individual contributions C2 to C6 can be considered.

Subsequently, the overall relationship between the gene expression regulatory sequence X and the biological phenomenon Z is considered. In FIG. 5, the regulatory-side contributions A1 to A6 vary in magnitude from small to large, and also the phenomenon-side contributions B1 to B6 vary in magnitude from small to large. However, it is considered that any contribution has an effect on the relationship between the gene expression regulatory sequence X and the biological phenomenon Z. Even if the regulatory-side contribution A1 is small or the phenomenon-side contribution B1 is small, the gene Y1 may be involved in the relationship between the gene expression regulatory sequence X and the biological phenomenon Z, therefore, it should be considered.

Accordingly, in this embodiment, a total contribution obtained by summing up the individual contributions C1 to C6 is considered. The total contribution is a sum of the individual contributions C1 to C6. This total contribution is a parameter that reflects the difference in the magnitude of the regulatory-side contributions A1 to A6 and phenomenon-side contributions B1 to B6.

Subsequently, a relationship between the above total contribution and a matrix calculation process of this embodiment will be explained. In FIG. 4, respective matrix elements of the primary matrix data correspond to the above regulatory-side contributions and respective matrix elements of the secondary matrix data correspond to the above phenomenon-side contributions. In FIG. 4, when the attention is paid to one gene expression regulatory sequence and one biological phenomenon, in the matrix calculation, a sum of the products of the regulatory-side contributions and the phenomenon-side contributions is calculated. That is, the total contribution in FIG. 5 is calculated.

Moreover, in the matrix calculation, the primary matrix data is data of combinations between a plurality of gene expression regulatory sequences and a plurality of genes, and the secondary matrix data is data of combinations between a plurality of genes and a plurality of biological phenomena. Therefore, the total contribution for various combinations between the plurality of gene expression regulatory sequences and the plurality of biological phenomena is efficiently and easily calculated.

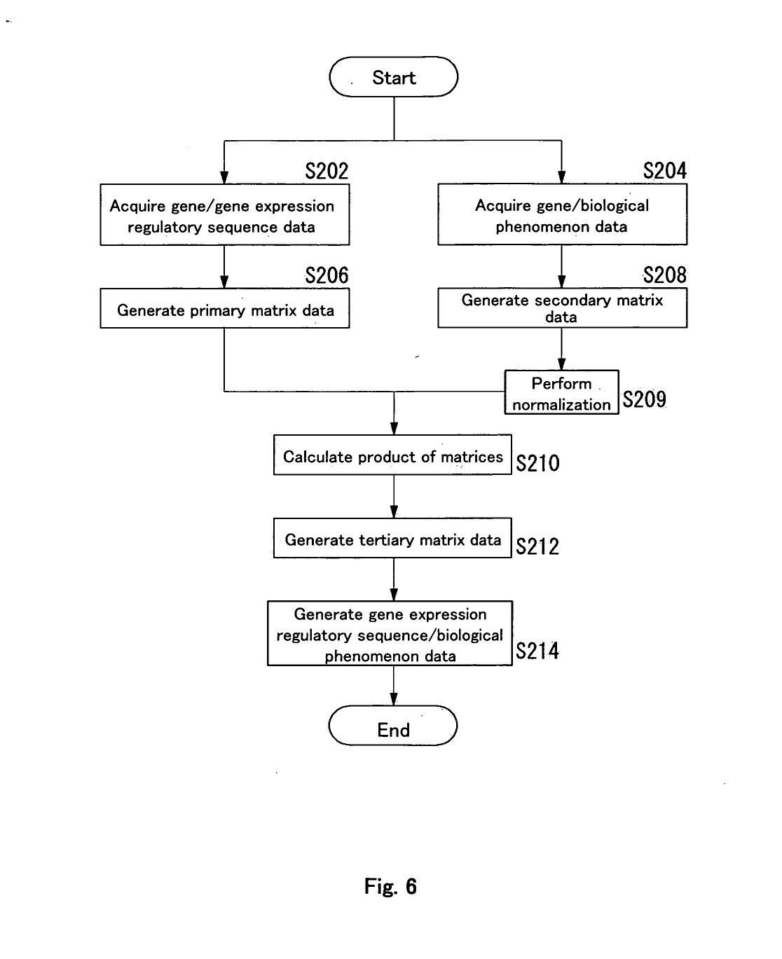

FIG. 6 is a flowchart for illustrating an operation performed by the bio-information analyzer according to the embodiment.

In the bio-information analyzer 100, when a series of operation is started, first, the gene expression regulatory sequence data acquisition unit 134 acquires gene expression regulatory sequence data from outside (S202), and primary matrix data is generated and stored in the gene expression regulatory sequence data storage unit 138 (S206).

On the other hand, the gene/biological phenomenon data acquisition unit 136 acquires gene/biological phenomenon data from outside (S204), and secondary matrix data is generated (S208), if necessary normalization which will be described later is performed (S209), and stored in the gene/biological phenomenon data storage unit 140.

Subsequently, the gene expression regulatory sequence/biological phenomenon data generation section 142 acquires the gene expression regulatory sequence data from the gene expression regulatory sequence data storage unit 138 and the gene/biological phenomenon data from the gene/biological phenomenon data storage unit 140.

Then, the gene expression regulatory sequence/biological phenomenon data generation section 142 calculates a product of matrices for creating a profile of a relationship between a biological phenomenon and a gene expression regulatory sequence candidate based on the gene expression regulatory sequence data and the gene/biological phenomenon data (S210), whereby tertiary matrix data is generated (S212). Further, the gene expression regulatory sequence/biological phenomenon data generation section 142 generates gene expression regulatory sequence/biological phenomenon data by using the tertiary matrix data (the result of the creation of the profile) (S214).

Further, when the gene expression regulatory sequence/biological phenomenon data is generated, the bio-information analyzer 100 stores the data in the gene expression regulatory sequence/biological phenomenon data storage unit 144. In general, the gene expression regulatory sequence/biological phenomenon data is generated and stored in a table (matrix) format.

Hereinabove, the gene expression regulatory sequence/biological phenomenon data generation function was described. Next, an advantage of this function will be described.

In this embodiment, as described above, the matrix data of gene expression regulatory sequence/biological phenomenon is obtained by a preferred process to calculate a product of the matrix of gene expression regulatory sequence data and the matrix of gene/biological phenomenon data. The thus calculated matrix data is a matrix of a total contribution described above. As described above, the total contribution reflects the regulatory-side contributions and the phenomenon-side contributions related to a plurality of genes, and becomes a parameter with a high reliability appropriately representing a relationship between a gene expression regulatory sequence and a biological phenomenon. Therefore, since a gene expression regulatory sequence with a higher relationship with a biological phenomenon is predicted as an actual gene expression regulatory sequence by calculating products of the above matrices for a number of gene expression regulatory sequences, it becomes possible to predict also a gene expression regulatory sequence that was difficult to be searched by an approach with the use of homology in a related art.

<2. Generation of Gene Expression Regulatory Sequence Data>

Next, a configuration for generating gene expression regulatory sequence data to be input as basic data for generating gene expression regulatory sequence/biological phenomenon data to the bio-information analyzer 100 will be explained.

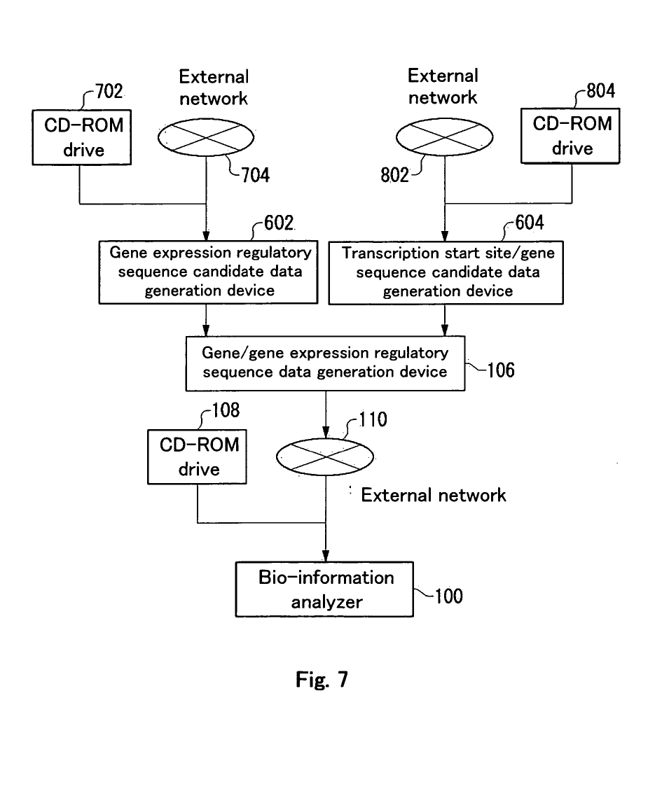

FIG. 7 is a functional block diagram for illustrating a configuration for generating gene expression regulatory sequence data. In FIG. 7, a gene expression regulatory sequence candidate data generation device 602, a transcription start site/gene sequence candidate data generation device 604 and a gene expression regulatory sequence data generation device 106 are provided.

The gene expression regulatory sequence candidate data generation device 602 is connected to a CD-ROM drive 702 or an external network 704, and information can be acquired from these. The transcription start site/gene sequence candidate data generation device 604 is connected to a CD-ROM drive 804 or an external network 802, and information can be acquired from these.

The gene expression regulatory sequence data generation device 106 is connected to the bio-information analyzer 100 via an external network 110, and information is input to the bio-information analyzer 100. As shown in the drawing, the bio-information analyzer 100 may accept similar data to that for the gene expression regulatory sequence data generation device 106 also from a CD-ROM drive 108.

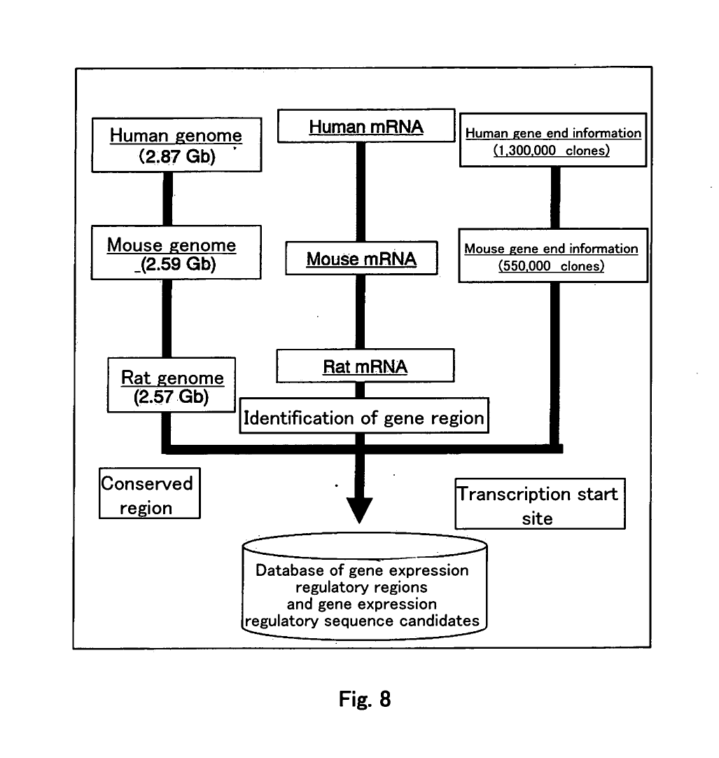

FIG. 8 is a schematic diagram for illustrating generation of gene expression regulatory sequence candidate data to be used in the bio-information analysis system according to the embodiment. As shown in FIG. 8, a database of transcription start sites and gene expression regulatory sequence candidates can be generated by the following steps.

Step 1: Determine a gene region (cDNA) and a transcription start site upstream of a gene.

Step 2: Determine a homologous gene between species.

Step 3: Determine a genomic homologous region between species. That is, associate genomes between different species with each other.

Step 4: Determine a conserved region of the genome sequence between species. That is, the genomes are compared with each other. It is because the tendency that a nucleotide sequence which is important for the function of a living organism such as a gene expression regulatory sequence is conserved among species is strong.

Step 5: Search a candidate of a gene expression regulatory sequence that is conserved between species in the whole genome. At this time, the candidate of a gene expression regulatory sequence may be either a known sequence or a new sequence.

Step 6: Create a database by associating the gene expression regulatory sequence candidate with a gene and a transcription start site.

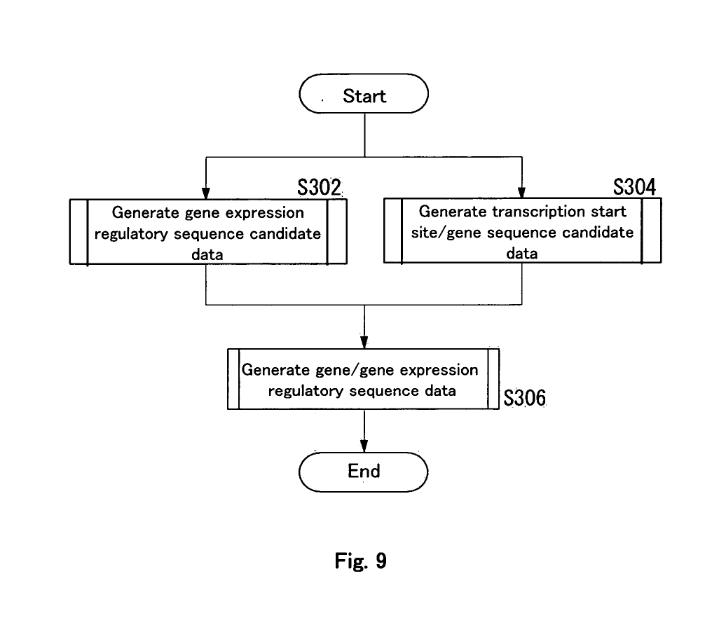

FIG. 9 is a flowchart illustrating generation of gene expression regulatory sequence data in the bio-information analysis system according to the embodiment.

In this case, first, the gene expression regulatory sequence candidate data generation device 602 generates gene expression regulatory sequence candidate data based on information from outside (S302). On the other hand, the transcription start site/gene sequence candidate data generation device 604 generates transcription start site/gene sequence candidate data based on information from outside separately (S304). Then, the gene expression regulatory sequence data generation device 106 generates gene expression regulatory sequence data based on these data (S306). The obtained gene expression regulatory sequence data is input to the bio-information analyzer 100.

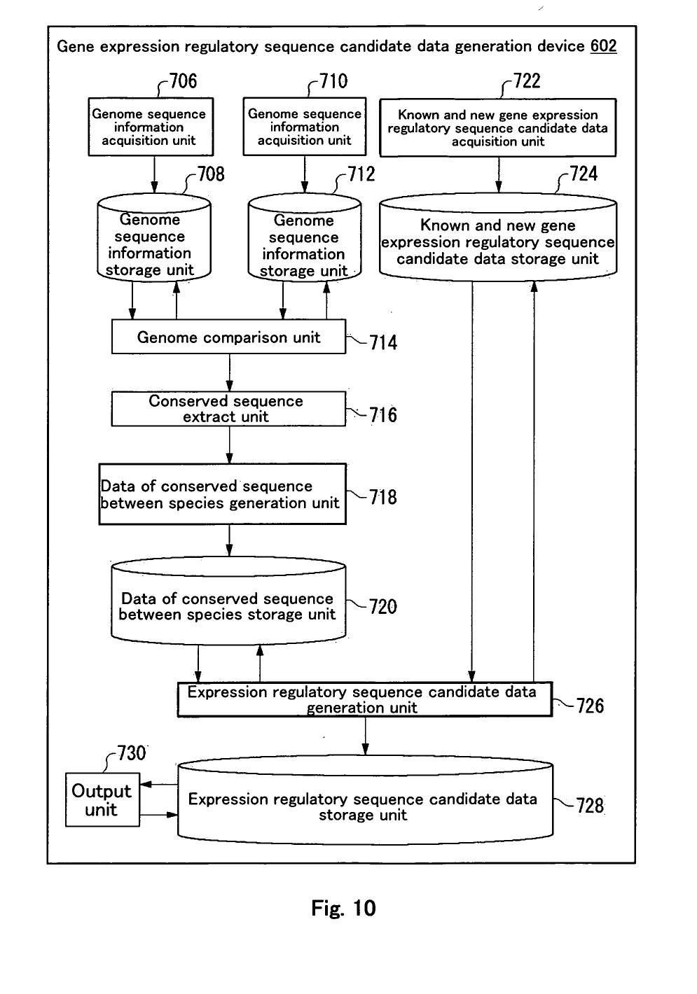

FIG. 10 is a functional block diagram showing the configuration of the gene expression regulatory sequence candidate data generation device 602 in FIG. 7. The gene expression regulatory sequence candidate data generation device 602 has a function of generating gene expression regulatory sequence candidate data in a given species from genome sequence information of a plurality of species including the given species and known and new gene expression regulatory sequence candidate data. Here, the known and new gene expression regulatory sequence candidate data is data including known gene expression regulatory sequence candidate data and new gene expression regulatory sequence candidate data which has been arbitrarily generated.

As shown in FIG. 7, the gene expression regulatory sequence candidate data generation device 602 is connected to the external CD-ROM drive 702 and the external network 704, and performs a process by incorporating information from these.

The gene expression regulatory sequence candidate data generation device 602 is equipped with a genome sequence information acquisition unit 706 that acquires the genome sequence information of a first species. The genome sequence information acquisition unit 706 stores the genome sequence information of the first species acquired from outside in a genome sequence information storage unit 708.

On the other hand, the gene expression regulatory sequence candidate data generation device 602 is equipped with a genome sequence information acquisition unit 710 that acquires the genome sequence information of a second species that is different from the first species. The genome sequence information acquisition unit 710 stores the genome sequence information of the second species acquired from outside in a genome sequence information storage unit 712.

The gene expression regulatory sequence candidate data generation device 602 is equipped with a genome comparison unit 714. The genome comparison unit 714 acquires the genome sequence information of the first species from the genome sequence information storage unit 708 and the genome sequence information of the second species from the genome sequence information storage unit 712.

Further, the genome comparison unit 714 compares the acquired genome sequence information of the first species with the genome sequence information of the second species and generates a comparison result with the use of a given index such as a nucleotide sequence homology. The genome comparison unit 714 sends the generated comparison result to a conserved sequence extract unit 716.

The conserved sequence extract unit 716 analyzes the comparison result obtained from the genome comparison unit 714 and extracts data of conserved sequences between species composed of a plurality of gene expression regulatory sequence candidates (gene expression regulatory sequence candidates) containing a sequence whose conservation level among the genome sequence information of a plurality of species is not lower than a predetermined level (for example, the DNA sequence homology is 70% or more). The conserved sequence extract unit 716 sends the extracted data of conserved sequence between species to a data of conserved sequence between species generation unit 718.

The data of conserved sequence between species generation unit 718 generates data of conserved sequence between species by associating the data of conserved sequence between species acquired from the conserved sequence extract unit 716 with a region corresponding to the genome sequence information of the first species or the second species, which is an analysis object. The data of conserved sequence between species generation unit 718 stores the generated data of conserved sequence between species in a data of conserved sequence between species storage unit 720.

On the other hand, the gene expression regulatory sequence candidate data generation device 602 is equipped with a known and new gene expression regulatory sequence candidate data acquisition unit 722 that acquires known and new gene expression regulatory sequence candidate data for the genome sequence information of the first species or the second species, which is an analysis object. The known and new gene expression regulatory sequence candidate data acquisition unit 722 stores the known and new gene expression regulatory sequence candidate data acquired from outside in a known and new gene expression regulatory sequence candidate data storage unit 724.

Further, the gene expression regulatory sequence candidate data generation device 602 is equipped with a gene expression regulatory sequence candidate data generation unit 726. The gene expression regulatory sequence candidate data generation unit 726 acquires data of conserved sequence between species from the data of conserved sequence between species storage unit 720 and known and new gene expression regulatory sequence candidate data from the known and new gene expression regulatory sequence candidate data storage unit 724.

Further, the gene expression regulatory sequence candidate data generation unit 726 generates, as data of a plurality of gene expression regulatory sequence candidates, gene expression regulatory sequence candidate data including known gene expression regulatory sequence candidate data and arbitrarily generated new gene expression regulatory sequence candidate data in addition to the above-mentioned data of conserved sequence between species. The gene expression regulatory sequence candidate data generation unit 726 stores the generated gene expression regulatory sequence candidate in a gene expression regulatory sequence candidate data storage unit 728.

The gene expression regulatory sequence candidate data generation device 602 is equipped with an output unit 730. The output unit 730 acquires the gene expression regulatory sequence candidate data from the gene expression regulatory sequence candidate data storage unit 728 and outputs it to the gene expression regulatory sequence data generation device 106.

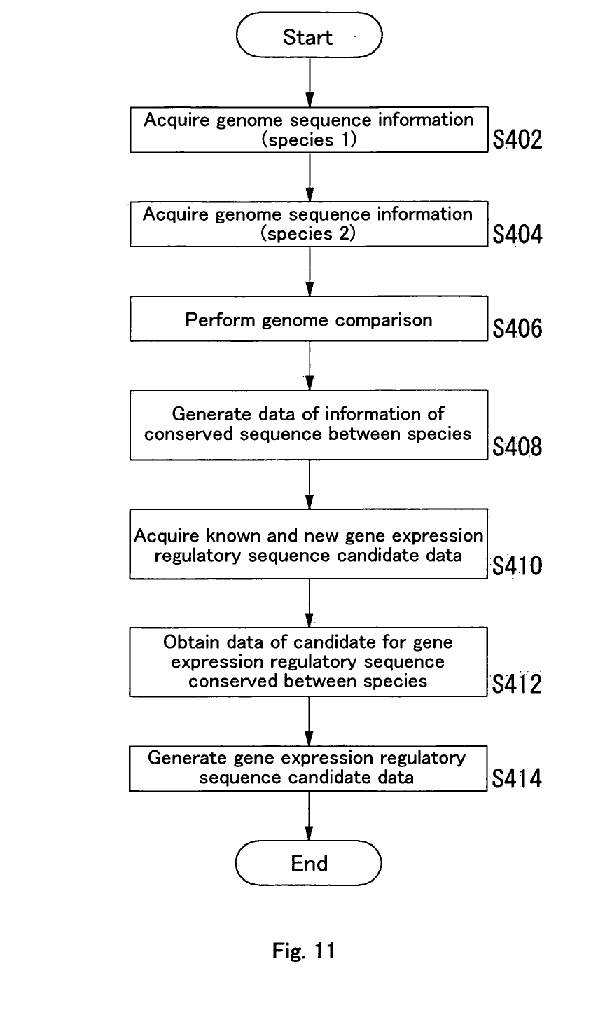

FIG. 11 is a flowchart for illustrating generation of gene expression regulatory sequence candidate data. This flowchart corresponds to a subroutine of the step 302 in FIG. 9.

In the gene expression regulatory sequence candidate data generation device 602, when a series of operation is started, first, the genome sequence information acquisition unit 706 acquires the genome sequence information of a species 1 from outside (S402). Then, the genome sequence information acquisition unit 706 stores the acquired genome sequence information in the genome sequence information storage unit 708.

On the other hand, the genome sequence information acquisition unit 710 acquires the genome sequence information of a species 2 from outside. Then, the genome sequence information acquisition unit 710 stores the acquired genome sequence information in the genome sequence information storage unit 712.

The decoding of genome sequences has been rapidly advanced in these years, and the genome sequence information of several species among mammals (human genome (complete) (2.87 Gb), mouse genome (draft) (2.59 Gb) and rat genome (draft) (2.57 Gb)) is available, and also those of chimpanzee and dog are being decoded. Therefore, such genome data can be preferably used.

Subsequently, the genome comparison unit 714 acquires the genome sequence information of the species 1 from the genome sequence information storage unit 708 and the genome sequence information of the species 2 from the genome sequence information storage unit 712 and compares both genome sequence information of the species 1 and the species 2 (S406). Then, the genome comparison unit 714 sends the comparison result of the genome sequence information of the species 1 and the species 2 to the conserved sequence extract unit 716.

When acquiring the comparison result of the genome sequence information of the species 1 and the species 2 from the genome comparison unit 714, the conserved sequence extract unit 716 extracts a sequence conserved in the genome sequence information of the species 1 and the species 2 based on the comparison result, and sends the conserved sequence between the species to the data of conserved sequence between species generation unit 718.

When acquiring the conserved sequence between the species from the conserved sequence extract unit 716, the data of conserved sequence between species generation unit 718 generates data of conserved sequence between species based on the conserved sequence between the species and the genome information of a species of an analysis object (S408). Then, the data of conserved sequence between species generation unit 718 stores the generated data of conserved sequence between species in the data of conserved sequence between species storage unit 720.

On the other hand, the known and new gene expression regulatory sequence candidate data acquisition unit 722 acquires known and new gene expression regulatory sequence candidate data from outside (S410). Then, the known and new gene expression regulatory sequence candidate data acquisition unit 722 stores the acquired known and new gene expression regulatory sequence candidate data in a known and new gene expression regulatory sequence candidate data storage unit 724.

After the above-mentioned series of operation, the gene expression regulatory sequence candidate data generation unit 726 acquires the data of conserved sequence between species from the data of conserved sequence between species storage unit 720 and the known and new gene expression regulatory sequence candidate data from the known and new gene expression regulatory sequence candidate data storage unit 724, and obtains data of a candidate for a gene expression regulatory sequence conserved between species based on the information (S412).

Then, the gene expression regulatory sequence candidate data generation unit 726 generates gene expression regulatory sequence candidate data by relating the data of a candidate for a gene expression regulatory sequence conserved between species to the genome information of a given species of an analysis object (S414). Further, the gene expression regulatory sequence candidate data generation unit 726 stores the generated gene expression regulatory sequence candidate data in the gene expression regulatory sequence candidate data storage unit 728.

Then, the output unit 730 acquires the gene expression regulatory sequence candidate data from the gene expression regulatory sequence candidate data storage unit 728 and outputs it to the gene expression regulatory sequence data generation device 106, and thus the series of operation of the gene expression regulatory sequence candidate data generation device 602 is completed.

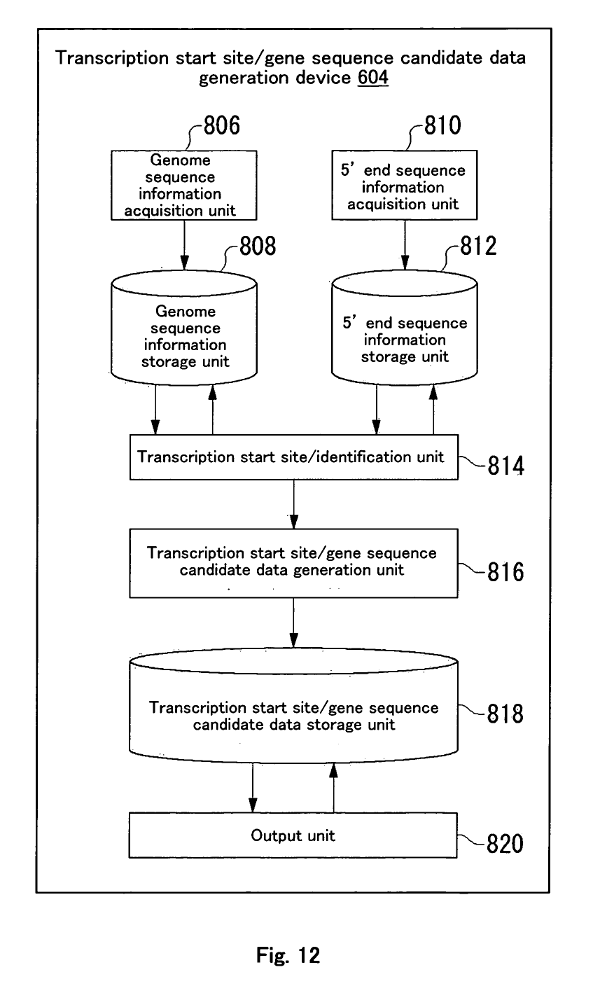

FIG. 12 is a functional block diagram showing the configuration of a transcription start site/gene sequence candidate data generation device 604 of FIG. 7. The transcription start site/gene sequence candidate data generation device 604 has a function of generating transcription start site/gene sequence candidate data from the genome sequence information of a given species of an analysis object and the 5′ end sequence information of a cDNA library of the given species of an analysis object.

The transcription start site/gene sequence candidate data generation device 604 is connected to the external CD-ROM drive 804 and the external network 802 as shown in FIG. 7, and performs a process by incorporating information from these.

The transcription start site/gene sequence candidate data generation device 604 is equipped with a genome sequence information acquisition unit 806 that acquires the genome sequence information of a given species of an analysis object. The genome sequence information acquisition unit 806 stores the genome sequence information acquired from outside in a genome sequence information storage unit 808.

On the other hand, the transcription start site/gene sequence candidate data generation device 604 is equipped with a 5′ end sequence information acquisition unit 810 that acquires the 5′ end sequence information of a cDNA library of a given species of an analysis object. The 5′ end sequence information acquisition unit 810 stores the 5′ end sequence information acquired from outside in a 5′ end sequence information storage unit 812.

The transcription start site/gene sequence candidate data generation device 604 is equipped with a transcription start site identification unit 814. The transcription start site identification unit 814 acquires the genome sequence information from the genome sequence information storage unit 808 and the 5′ end sequence information from the 5′ end sequence information storage unit 812. The transcription start site identification unit 814 identifies a transcription start site on the genome information of a given species of an analysis object based on the acquired genome sequence information and 5′ end sequence information. The transcription start site identification unit 814 sends the information related to the identified transcription start site to a transcription start site/gene sequence candidate data generation unit 816.

The transcription start site/gene sequence candidate data generation unit 816 generates transcription start site/gene sequence candidate data by associating a transcription start site corresponding to each 5′ end sequence with a gene sequence candidate located downstream of the 5′ end sequence based on the information related to the identified transcription start site acquired from the transcription start site identification unit 814. The transcription start site/gene sequence candidate data generation unit 816 stores the generated transcription start site/gene sequence candidate data in a transcription start site/gene sequence candidate data storage unit 818.

The transcription start site/gene sequence candidate data generation device 604 is equipped with an output unit 820. The output unit 820 acquires the transcription start site/gene sequence candidate data from the transcription start site/gene sequence candidate data storage unit 818 and outputs it to the gene expression regulatory sequence data generation device 106.

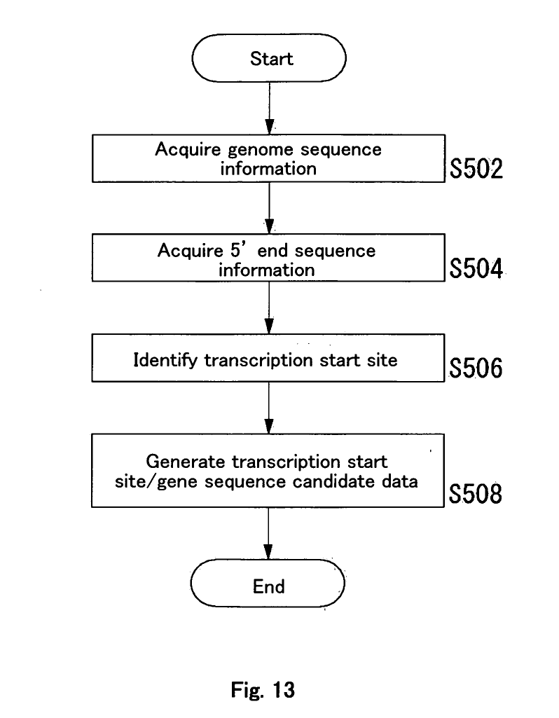

FIG. 13 is a flowchart illustrating generation of transcription start site/gene sequence candidate data in the bio-information analysis system according to the embodiment. This flowchart corresponds to a subroutine of the step 304 in FIG. 9.

In the transcription start site/gene sequence candidate data generation device 604, when a series of operation is started, first, the genome sequence information acquisition unit 806 acquires the genome sequence information of a given species of an analysis object from outside (S502). Then, the genome sequence information acquisition unit 806 stores the acquired genome sequence information in the genome sequence information storage unit 808.

On the other hand, the 5′ end sequence information acquisition unit 810 acquires the 5′ end sequence information of a cDNA library from outside (S504). Then, the 5′ end sequence information acquisition unit 810 stores the acquired 5′ end sequence information in the 5′ end sequence information storage unit 812.

Then, the transcription start site identification unit 814 acquires the genome sequence information from the genome sequence information storage unit 808 and the 5′ end sequence information from the 5′ end sequence information storage unit 812, and identifies a transcription start site on the genome sequence information of a given species of an analysis object based on the acquired information (S506). The transcription start site identification unit 814 sends the information related to the identified transcription start site to the transcription start site/gene sequence candidate data generation unit 816.

The transcription start site/gene sequence candidate data generation unit 816 generates transcription start site/gene sequence candidate data by relating the information related to the transcription start site acquired from the transcription start site identification unit 814 to the genome sequence information of a given species of an analysis object (S508), and stores it in the transcription start site/gene sequence candidate data storage unit 818.

Then, the output unit 820 acquires the transcription start site/gene sequence candidate data from the transcription start site/gene sequence candidate data storage unit 818 and outputs it to the gene expression regulatory sequence data generation device 106, and the series of operation of the transcription start site/gene sequence candidate data generation device 604 is completed.

In this way, the transcription start site/gene sequence candidate data generation device 604 identifies a plurality of transcription start sites in the genome sequence information of a given species of an analysis object based on a plurality of gene sequence candidates in the genome sequence information of the given species of an analysis object and 5′ end sequences of a plurality of cDNA sequences in the genome sequence information of the given species of an analysis object.

More specifically, the transcription start site/gene sequence candidate data generation device 604 associates the gene sequence candidate located downstream of the 5′ end sequence with the 5′ end sequence for each of the plurality of cDNA sequences. Then, the transcription start site/gene sequence candidate data generation device 604 generates the transcription start site/gene sequence candidate data by associating the gene sequence candidate with the transcription start site corresponding to the 5′ end sequence associated with the gene sequence candidate.

Further, also for the 5′ end sequence, the end information of a genome-wide cDNA library becomes available in recent years, therefore in order to determine a gene expression regulatory region, a transcription start site upstream of a gene can be determined by using the end information of a cDNA library.

As the 5′ end sequence information of a cDNA library, about 1,300,000 Human clones (NEDO/the Institute of Medical Science, the University of Tokyo, oligo-capping method) is available for organizations in Japan participating in the Consortium. Incidentally, an association in Japan that applies for participation in the Consortium can participate the Consortium by paying a predetermined fee. In addition, as another 5′ end sequence information of a cDNA library, about 550,000 Mouse clones (the RIKEN Genome Sciences Center, CAP-trapper method) and the like are available to the public.

Further, by using the 5′ end sequence information of these cDNA libraries, the inventors have already searched the gene expression regulatory regions and the gene expression regulatory sequence candidates in the whole genome for human, mouse and rat and created databases thereof.

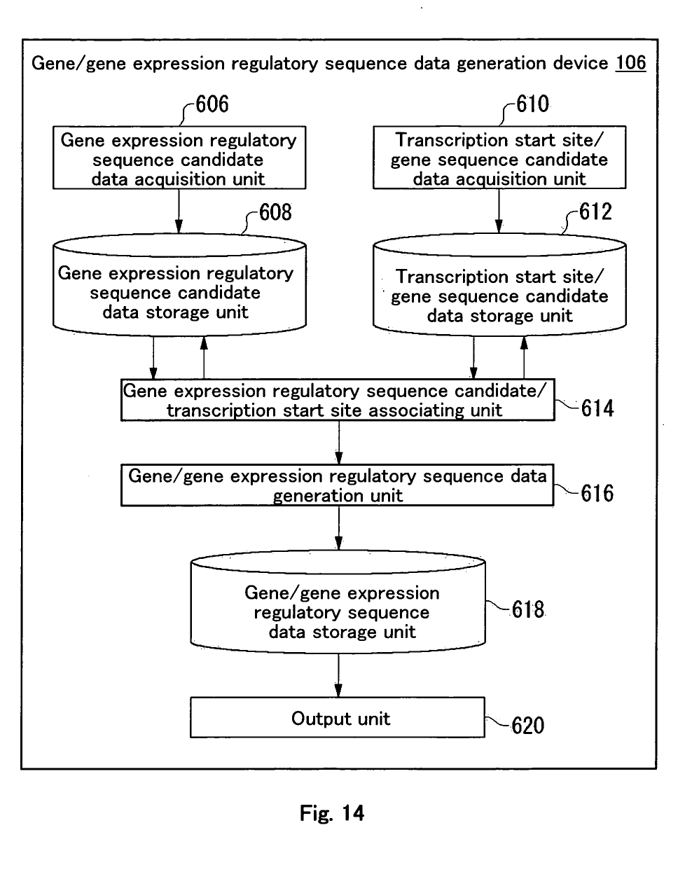

FIG. 14 is a functional block diagram showing the configuration of the gene expression regulatory sequence data generation device 106 of FIG. 7. The gene expression regulatory sequence data generation device 106 has a function of generating gene expression regulatory sequence data from gene expression regulatory sequence candidate data and transcription start site/gene sequence candidate data.

The gene expression regulatory sequence data generation device 106 is equipped with a gene expression regulatory sequence candidate data acquisition unit 606 that acquires gene expression regulatory sequence candidate data from the gene expression regulatory sequence candidate data generation device 602. The gene expression regulatory sequence candidate data acquisition unit 606 stores the acquired gene expression regulatory sequence candidate data in a gene expression regulatory sequence candidate data storage unit 608.

On the other hand, the gene expression regulatory sequence data generation device 106 is equipped with a transcription start site/gene sequence candidate data acquisition unit 610 that acquires transcription start site/gene sequence candidate data from the transcription start site/gene sequence candidate data generation device 604. The transcription start site/gene sequence candidate data acquisition unit 610 stores the acquired transcription start site/gene sequence candidate data in a transcription start site/gene sequence candidate data storage unit 612.

Further, the gene expression regulatory sequence data generation device 106 is equipped with a gene expression regulatory sequence candidate/transcription start site associating unit 614. The gene expression regulatory sequence candidate/transcription start site associating unit 614 acquires the gene expression regulatory sequence candidate data from the gene expression regulatory sequence candidate data storage unit 608 and the transcription start site/gene sequence candidate data from the transcription start site/gene sequence candidate data storage unit 612, and generates data by associating the gene expression regulatory sequence candidate located in the upstream within a predetermined distance from each of the transcription start sites with the transcription start site based on the acquired data.

At this time, the association can be carried out based on a contribution according to the distance between each of the transcription start sites and the gene expression regulatory sequence candidate. The gene expression regulatory sequence candidate/transcription start site associating unit 614 sends the data generated by associating the gene expression regulatory sequence candidate with the transcription start site to a gene expression regulatory sequence data generation unit 616.

The gene expression regulatory sequence data generation device 106 is equipped with the gene expression regulatory sequence data generation unit 616. The gene expression regulatory sequence data generation unit 616 generates gene expression regulatory sequence data which is data obtained by associating the gene expression regulatory sequence candidate associated with each of the transcription start sites with a gene associated with the transcription start site based on the data obtained by associating the gene expression regulatory sequence candidate with the transcription start site acquired from the gene expression regulatory sequence candidate/transcription start site associating unit 614. The gene expression regulatory sequence data generation unit 616 stored the generated gene expression regulatory sequence data in a gene expression regulatory sequence data storage unit 618.

The gene expression regulatory sequence data generation device 106 is equipped with an output unit 620. The output unit 620 acquires the gene expression regulatory sequence data from the gene expression regulatory sequence data storage unit 618 and outputs it to the bio-information analyzer 100 via the external network 110.

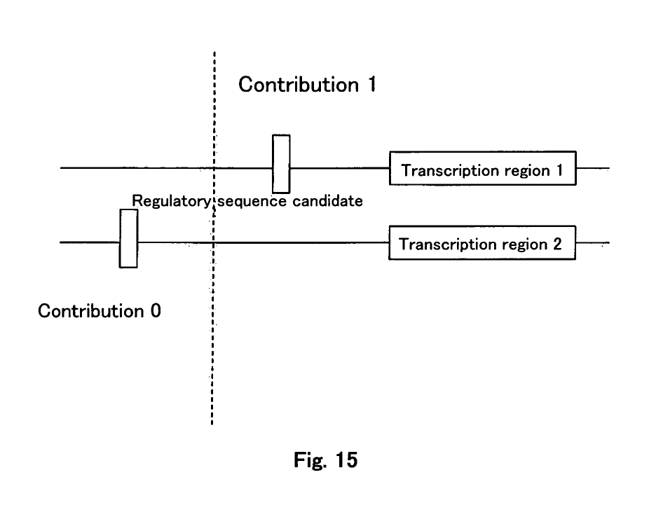

FIG. 15 is a schematic diagram for illustrating setting of a contribution of gene expression regulatory sequence data. In this setting, as for a certain gene expression regulatory sequence (candidate), the number of genes having a relationship with the sequence is set.

At this time, the number of genes having the gene expression regulatory sequence varies depending on the distance from the vicinity of the transcription start site upstream of the gene to be searched. That is, the analysis result varies depending on the number of genes having the gene expression regulatory sequence to be evaluated.

More specifically, the distance from the vicinity of the transcription start site to be searched varies depending on the gene expression regulatory sequence candidate. That is, a lot of gene expression regulatory sequence candidates for which the distance necessary for the search is short exist on the genome and a few gene expression regulatory sequence candidates for which the distance necessary for the search is long exist on the genome, therefore, the distance from the transcription start site upstream of the gene to be evaluated should be determined depending on the respective gene expression regulatory sequence candidates.

In this embodiment, the number of genes with which the gene expression regulatory sequence is associated is changed within the range of, for example, 1 to 500, and the significances are obtained by comparison with random data for the cases of the respective numbers, and then the number of genes with the highest significance may be set. Alternatively, the distance from the vicinity of the transcription start site upstream of the gene to be searched may be simply set.

Alternatively, when the sequence information of cDNA clones is available, each of a plurality of transcription start sites corresponding to a plurality of 5′ end sequences may be determined as a constituent that can be associated with the gene sequence candidate located downstream of each of the 5′ end sequences in the respective plurality of cDNA sequences.

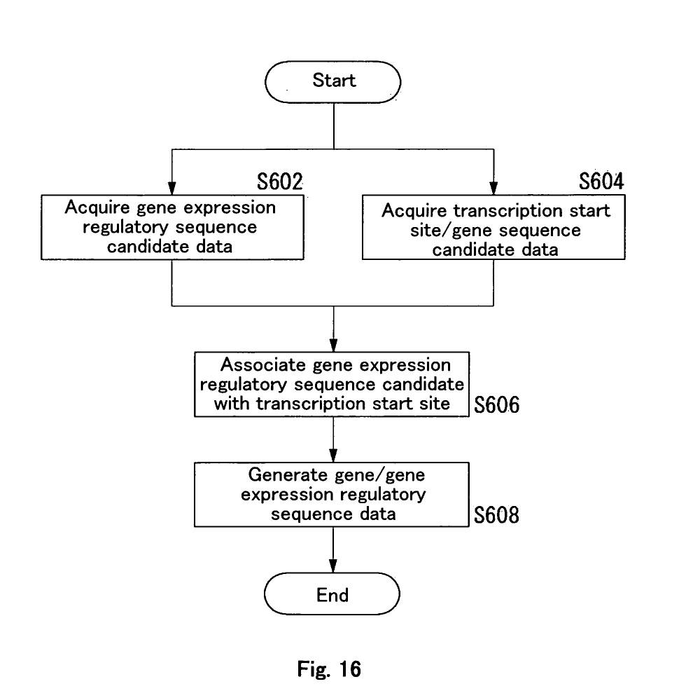

FIG. 16 is a flowchart illustrating generation of gene expression regulatory sequence data by the gene expression regulatory sequence data generation device 106. This flowchart is a subroutine of the step 306 in FIG. 9.

In the gene expression regulatory sequence data generation device 106, when a series of operation is started, first, the gene expression regulatory sequence candidate data acquisition unit 606 acquires gene expression regulatory sequence candidate data from a server (S602). Then, the gene expression regulatory sequence candidate data acquisition unit 606 stores the acquired gene expression regulatory sequence candidate data in the gene expression regulatory sequence candidate data storage unit 608.

On the other hand, the transcription start site/gene sequence candidate data acquisition unit 610 acquires transcription start site/gene sequence candidate data from the transcription start site/gene sequence candidate data generation device 604 (S604). Then, the transcription start site/gene sequence candidate data acquisition unit 610 stores the acquired transcription start site/gene sequence candidate data in the transcription start site/gene sequence candidate data storage unit 612.

Subsequently, the gene expression regulatory sequence candidate/transcription start site associating unit 614 acquires the gene expression regulatory sequence candidate data from the gene expression regulatory sequence candidate data storage unit 608 and the transcription start site/gene sequence candidate data from the transcription start site/gene sequence candidate data storage unit 612, and associates the gene expression regulatory sequence with the transcription start site based on a contribution according to the distance between the gene expression regulatory sequence and the transcription start site based on the acquired data (S606) Then, the gene expression regulatory sequence candidate/transcription start site associating unit 614 sends the data obtained by associating the gene expression regulatory sequence with the transcription start site to the gene expression regulatory sequence data generation unit 616.

Subsequently, the gene expression regulatory sequence data generation unit 616 generates gene expression regulatory sequence data based on the data obtained by associating the gene expression regulatory sequence with the transcription start site based on a contribution according to the distance between the gene expression regulatory sequence and the transcription start site acquired from the gene expression regulatory sequence candidate/transcription start site associating unit 614 (S608). Then, the gene expression regulatory sequence data generation unit 616 stores the generated gene expression regulatory sequence data in the gene expression regulatory sequence data storage unit 618.

Then, the output unit 620 acquires the gene expression regulatory sequence data from the gene expression regulatory sequence data storage unit 618 and outputs it to the gene expression regulatory sequence data acquisition unit 134 in the bio-information analyzer 100 via the external network 110, and the series of operation of the gene expression regulatory sequence data generation device 106 is completed.

Hereinabove, the process of generating gene expression regulatory sequence data was described. This data is input to the bio-information analyzer 100 as basic data for analysis in the bio-information analyzer 100 as already described above.

In this embodiment, as described above, the gene expression regulatory sequence data can be obtained based on a plurality of genes in the genome sequence information of a given species, a gene expression regulatory sequence in the genome sequence information and a plurality of transcription start sites associated with each of the plurality of genes in the genome sequence information.

More specifically, the gene expression regulatory sequence data can be obtained by associating the gene expression regulatory sequence located within a predetermined distance from a transcription start site or within a predetermined order in the upstream of the transcription start site associated with a gene in the genome sequence information with the gene based on a predetermined contribution.

At this time, the gene expression regulatory sequence can be associated with the gene based on a contribution according to the distance between the transcription start site and the gene expression regulatory sequence or the number of gene expression regulatory sequences.

For example, when the distance is within a predetermined first distance, the contribution is determined to be 2, when it exceeds the predetermined first distance but within a predetermined second distance, the contribution is determined to be 1, and when it exceeds the predetermined second distance, the contribution is determined to be 0. Alternatively, when the number is not more than 10, the contribution is determined to be 2, when the number is not more than 50, the contribution is determined to be 1, and when the number exceeds 50, the contribution is determined to be 0.

Hereinafter, an advantage related to the process of generating gene expression regulatory sequence data in this embodiment will be described.

In this embodiment, a database of information of conserved sequence between species on the genome of a given species of an analysis object is created. That is, in the bio-information analyzer 100, by performing comparison analysis of genome sequences of arbitrary species including a plurality of vertebrate species, a genome sequence conserved among species is identified and a database of such sequences is created. As a gene expression regulatory sequence, a genome sequence which is important for the function of living organisms is expected to be conserved among species, by creating this database and searching a gene expression regulatory sequence for the genome sequence information conserved among species, it becomes possible to narrow the search space for a broad gene expression regulatory sequences of arbitrary species including higher eukaryotes.

Further, in this embodiment, in the transcription start site/gene sequence candidate data generation unit, by using the 5′ end sequence information of a cDNA library of an arbitrary species including a vertebrate, comprehensive transcription start sites are identified and a database thereof is created. Accordingly, by creating such database and utilizing the information of the comprehensive transcription start sites upstream of genes of an arbitrary species including a vertebrate, it becomes easy to search a gene expression regulatory sequence in the vicinity of the transcription start site of RNA from the genome DNA of an arbitrary species including a vertebrate, which was difficult with a related art.

Further, in this embodiment, the contribution between a gene expression regulatory sequence candidate and a gene downstream of a transcription start site is set based on a contribution according to the distance between the gene expression regulatory sequence candidate and the transcription start site, therefore, the distance from the vicinity of the transcription start site to be searched can be arbitrarily set according to the gene expression regulatory sequence candidate. That is, according to the searching conditions for the respective gene expression regulatory sequence candidates, the distance from the transcription start site upstream of a gene to be evaluated can be determined. Thus, the efficiency of the search for a gene expression regulatory sequence candidate corresponding to a gene sequence candidate can be improved.

<3. Generation of Gene/Biological Phenomenon Data>

Next, the configuration for generating gene/biological phenomenon data will be described. The gene/biological phenomenon data is input to the bio-information analyzer 100 and becomes basic data for analysis in the bio-information analyzer 100 in the same manner as the above-mentioned gene expression regulatory sequence data.

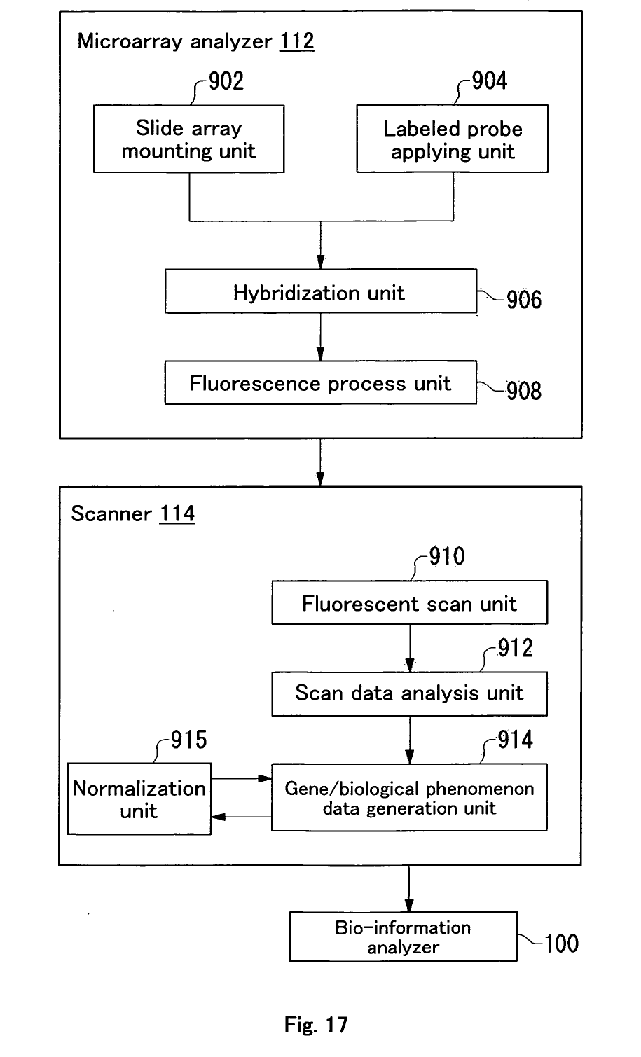

FIG. 17 is a functional block diagram showing the configurations of a microarray analyzer and a scanner. A microarray analyzer 112 and a scanner 114 have functions of analyzing a microarray and generating gene/biological phenomenon data.

The gene/biological phenomenon data processed in the bio-information analyzer 100 is data related to an expression intensity of a gene sequence candidate. More specifically, the gene/biological phenomenon data processed in the bio-information analyzer 100 is data obtained by analyzing each cell of a microarray as described below.

The microarray analyzer 112 is equipped with a slide array mounting unit 902 on which a slide array having sample DNA spotted thereof is mounted. Further, the microarray analyzer 112 is equipped with a labeled probe applying unit 904 that applies sample RNA, which is sampled from a biological specimen and labeled to form a labeled probe, to the slide array.

Further, the microarray analyzer 112 is equipped with a hybridization unit 906 that allows the sample DNA spotted on the slide array to hybridize to the labeled sample RNA applied to the slide array. Further, the microarray analyzer 112 is equipped with a fluorescence process unit 908 that performs a fluorescence process of the hybridized labeled RNA.

Further, the scanner 114 is equipped with a fluorescent scan unit 910 that performs fluorescent scanning of the slide array undergoing the fluorescence process by the fluorescence process unit 908. Further, the scanner 114 is equipped with a scan data analysis unit 912 that analyzes the fluorescent scanning data acquired by the fluorescent scan unit 910 and generates expression data of the sample RNA.

Further, the scanner 114 is equipped with a gene/biological phenomenon data generation unit 914 that acquires the expression data of the sample RNA generated by the scan data analysis unit 912 and generates gene/biological phenomenon data whose data elements are expression intensity of the mRNA of a gene. The gene/biological phenomenon data generation unit 914 outputs the generated gene/biological phenomenon data to the bio-information analyzer 100.

The gene/biological phenomenon data generation unit 914 that generates gene/biological phenomenon data may be connected to a normalization unit 915 which will be described later. In this case, when the generated gene/biological phenomenon data includes variation, the analysis accuracy of the bio-information analysis system 1000 can be improved by normalizing the data using the normalization unit 915.

In this way, the microarray analyzer 112 and the scanner 114 analyze a microarray and generate gene/biological phenomenon data. That is, the gene/biological phenomenon data is data obtained by a microarray assay. The gene/biological phenomenon data is data of contributions of combinations of each of a plurality of genes and each of a plurality of biological phenomena, and the contribution is a value generated from the mRNA expression level of a gene.

At this time, the gene/biological phenomenon data is generated as secondary matrix data. In addition, in this secondary matrix data, the contribution of a combination of a gene (gene sequence candidate) and a biological phenomenon is a value generated from the expression intensity of the gene (gene sequence candidate). More specifically, the contribution of a combination of a gene (gene sequence candidate) and a biological phenomenon is a value generated from the mRNA expression level of the gene (gene sequence candidate).

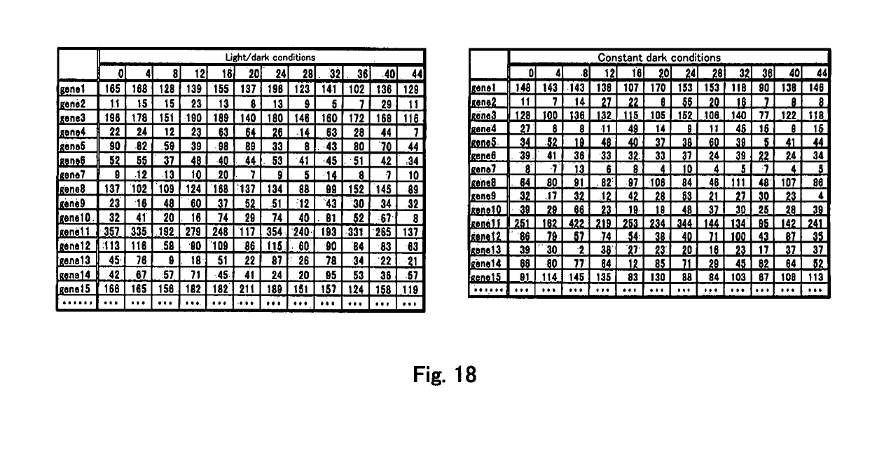

FIG. 18 is a data structure diagram for illustrating gene/biological phenomenon data. Here, a sample is obtained in two conditions, light/dark conditions and constant dark conditions. Sampling is performed every 4 hours for 2 days, i.e., 12 times in total in the respective conditions.

Further, in order to improve the reliability of data, investigation is performed for the total of 4 types of gene expression data, i.e., with two types of DNA chips (Affymetrix M430, MG-U74) for samples derived from two tissues (liver and suprachiasmatic nucleus).

More specifically, the relationship with the biological clock (gene expression changes in a time-dependent manner) is analyzed for known gene expression regulatory sequences and about 44,000 types of random sequences composed of 4 to 8 nucleotides.

As for the data to be used, gene expression data (the number of genes is 20,000 to 40,000) of the 12 time points in the two conditions are used for one tissue/one type of DNA chip, and data for two tissues and two DNA chips are used. That is, gene expression data of the total of 192 points are used for each gene.

As described above, for example, when the microarray analyzer 112 performs sampling of sample RNA from a biological specimen at a predetermined time interval, a time-series data of RNA expression level can be obtained. At this time, the biological phenomenon is a biological phenomenon related to a time series.

Alternatively for example, when the microarray analyzer 112 performs sampling of sample RNA from biological specimens with different diseases (or a biological specimen with a given disease and a healthy biological specimen), data showing the RNA expression levels for the respective diseases (or the RNA expression levels in the case of a given disease and in the healthy case) can be obtained. At this time, the biological phenomenon is a biological phenomenon related to a disease.

Alternatively for example, when the microarray analyzer 112 performs sampling of sample RNA from biological specimens in different tissues, data showing the RNA expression levels for the respective tissues can be obtained. At this time, the biological phenomenon is a biological phenomenon related to a tissue.

With the use of DNA chip or a microarray, a number of genes, for example 40,000 genes or more per about 1 cm² can be analyzed by performing an exhaustive analysis of the entire gene expression. A technique using such DNA chip has spread rapidly in recent years, and by allowing a DNA probe immobilized on DNA chip to hybridize to a fluorescently labeled sample (fluorescently labeled sample+DNA probe) and performing scanning, image data of DNA chip analysis can be obtained. When the image data of the DNA chip analysis is analyzed, the expression intensity of each sample RNA can be determined.

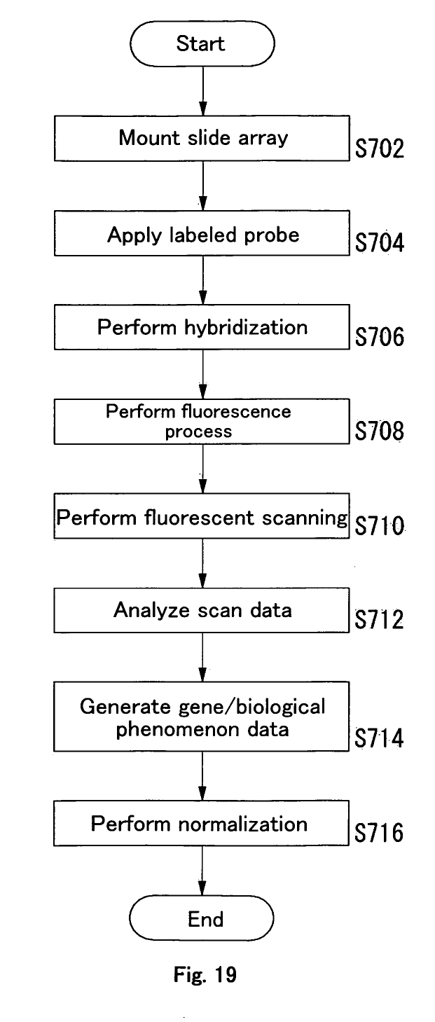

FIG. 19 is a flowchart illustrating generation of gene/biological phenomenon data by a microarray analyzer and a scanner of FIG. 17.

In this case, when a series of flow is started, first, in the microarray analyzer 112, a slide array is mounted on the slide array mounting unit 902 (S702). Then, the labeled probe applying unit 904 applies a sample labeled with such as a fluorescent protein to the slide array (S704). Subsequently, hybridization of the slide array to the labeled probe is allowed to proceed in the hybridization unit 906 (S706). Further, in the fluorescence process unit 908, the hybridized slide array undergoes a fluorescence process (S708)

Then, in the scanner 114, the slide array undergoing the fluorescence process is fluorescence-scanned in the fluorescent scan unit 910 (S710). Subsequently, in the scan data analysis unit 912, fluorescence-scanned scan data is analyzed (S712). Then, in the gene/biological phenomenon data generation unit 914, gene/biological phenomenon data is generated from the scan data (S714). Further, the gene/biological phenomenon data undergoes a normalization process which will be described later (S716) as needed.

As described above, since the bio-information analysis system 1000 is equipped with the microarray analyzer 112 and the scanner 114 for analyzing gene expression data of microarray, change data of gene expression level corresponding to a change in a given biological phenomenon is read from the microarray and gene/biological phenomenon data can be generated.

<4. Judgment of Significance>

Next, the configuration related to the significance judgment function 103 in the bio-information analyzer of FIG. 1 will be described. As for the significance judgment, the following three steps will be explained.
(A) Prediction of biological clock dependent-gene expression regulatory sequence
(B) Elucidation of regulation mechanism of cancer gene
(C) Elucidation of difference in gene regulation for each tissue
(D) Prediction of biological clock dependent-gene expression regulatory sequence

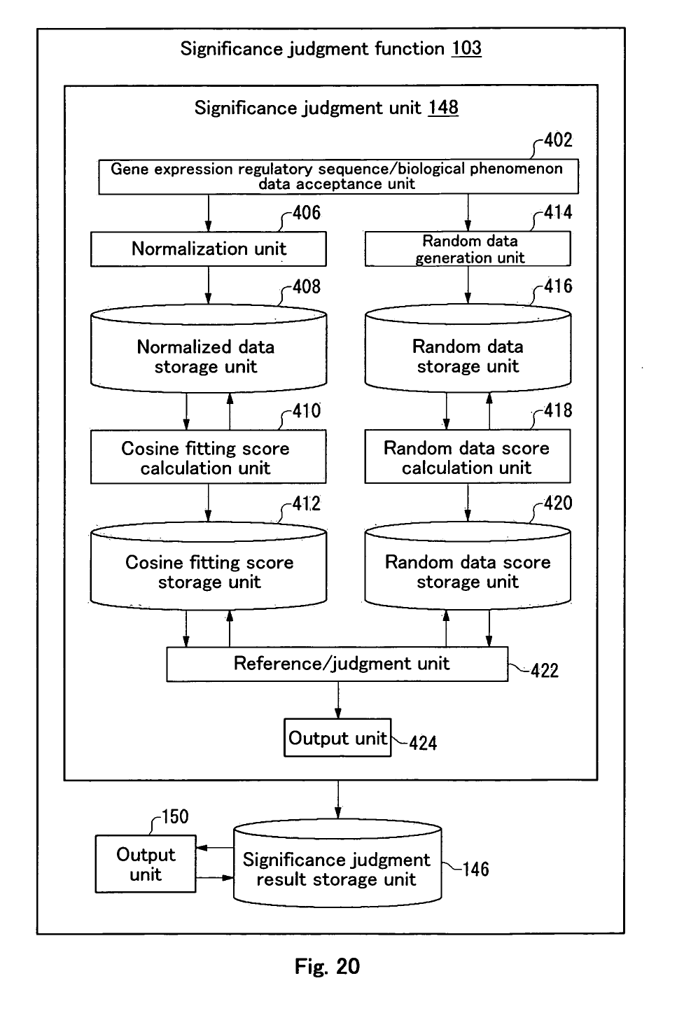

FIG. 20 shows the configuration related to the significance judgment function 103 in the bio-information analyzer 100 shown in FIG. 1. The significance judgment function 103 is equipped with the significance judgment unit 148. The significance judgment unit 148 acquires gene expression regulatory sequence/biological phenomenon data from the gene expression regulatory sequence/biological phenomenon data storage unit 144 shown in FIG. 2. The significance judgment unit 148 judges whether there is a significant relationship among the respective combinations between gene expression regulatory sequences and biological phenomena included in the acquired gene expression regulatory sequence/biological phenomenon data, and generates a significance judgment result.

More specifically, the significance judgment unit 148 acquires tertiary matrix data (FIG. 3C) which is gene expression regulatory sequence/biological phenomenon data from the gene expression regulatory sequence/biological phenomenon data storage unit 144. The significance judgment unit 148 judges whether there is a significant relationship among the respective combinations between gene expression regulatory sequences and biological phenomena included in the acquired tertiary matrix data, and generates a significance judgment result.

Further, the significance judgment function 103 is equipped with a significance judgment result storage unit 146. When a significance judgment result is generated, the significance judgment function 103 stores the data corresponding to the result in the significance judgment result storage unit 146. In general, the significance judgment result is generated and stored in a table (matrix) format.

The significance judgment function 103 is equipped with an output unit 150. The output unit 150 acquires the significance judgment result from the significance judgment result storage unit 146. The output unit 150 outputs the significance judgment result to the outside. In general, the analysis result is generated and output in a given format such as table (matrix) or image data depending on the structure of a device to which the data is output.

Next, each component of the significance judgment unit 148 will be described. The significance judgment unit 148 is equipped with a gene expression regulatory sequence/biological phenomenon data acceptance unit 402 that accepts tertiary matrix data (gene expression regulatory sequence/biological phenomenon data) from the gene expression regulatory sequence/biological phenomenon data storage unit 144. When accepting the gene expression regulatory sequence/biological phenomenon data, the gene expression regulatory sequence/biological phenomenon data acceptance unit 402 sends the data to a normalization unit 406 and a random data generation unit 414.

The normalization unit 406 that acquires the gene expression regulatory sequence/biological phenomenon data normalizes the gene expression regulatory sequence/biological phenomenon data according to a normalization protocol, which will be described later, and stores the normalized data in a normalized data storage unit 408.

A cosine fitting score calculation unit 410 acquires the normalized data from the normalized data storage unit 408, performs fitting with a cosine curve, which has been prepared in advance, calculates a cosine fitting score (correlation: correlation coefficient) and stores the score in a cosine fitting score storage unit 412.

The random data generation unit 414 randomly acquires part of tertiary matrix data (gene expression regulatory sequence/biological phenomenon data) from the gene expression regulatory sequence/biological phenomenon data storage unit 144, which will be described later. The random data generation unit 414 sends the part of tertiary matrix data randomly acquired from the gene expression regulatory sequence/biological phenomenon data storage unit 144 to a random data storage unit 416.

A random data score calculation unit 418 acquires the random data from the random data storage unit 416 and calculates random data score by applying the same processing as that for the gene expression regulatory sequence/biological phenomenon data accepted by the normalization unit 406 to the random data. That is, in this case, normalization and cosine fitting are performed in the same conditions. The random data score calculation unit 418 stores the random data score obtained by calculation in a random data score storage unit 420.

A reference/judgment unit 422 acquires the cosine fitting score from the cosine fitting score storage unit 412 and the random data from the random data score storage unit 420, judges whether or not a significant result (significant difference) between both of the acquired data can be obtained by comparing them, and sends the obtained significance judgment result to an output unit 424. The output unit 424 stores the obtained significance judgment result in the significance judgment result storage unit 146.

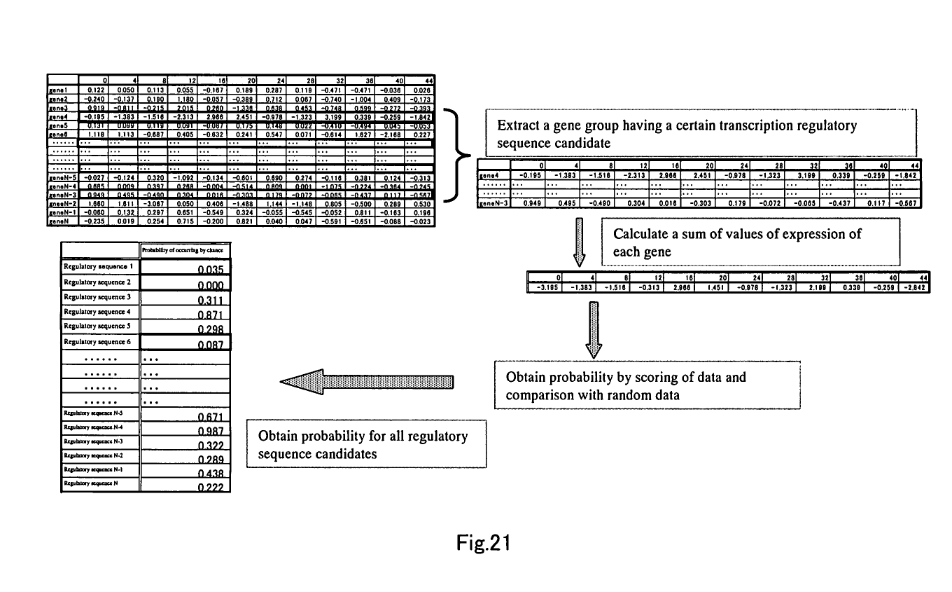

FIG. 21 is a data structure diagram for illustrating the overall flow of data processing in the significance judgment unit 148. As data processing method in this case, first, as for a gene having a transcription regulatory sequence candidate, a sum of values of gene expression of the respective genes corresponding to the transcription regulatory sequence candidate is calculated.

Then, the calculated sum for the gene expression is scored, and the significance is obtained from the distribution of the scores for random data (a probability of occurring by chance is obtained). Then, calculation for all the transcription regulatory sequence candidates to be an object is performed, and the transcription regulatory sequence candidate with significance of not lower than a predetermined threshold (the probability of occurring by chance is low) is output as a predicted transcription regulatory sequence candidate.

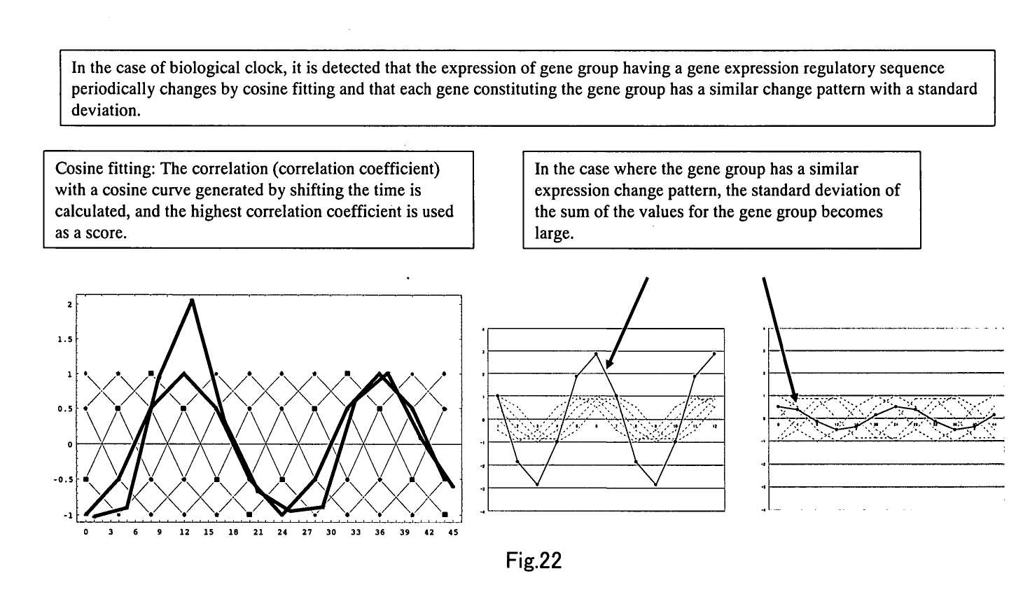

FIG. 22 shows graphs for illustrating scoring of data by cosine fitting or the like in the significance judgment unit 148. In this case, a method of scoring of final data is changed depending on the type of data (biological phenomenon). Further, as described later, in the case of comparing two tissues as a case of another embodiment, evaluation is performed simply using an expression intensity, however, in the case of a biological clock as a case of this embodiment, evaluation is performed by cosine fitting and with a standard deviation.

Further, it was decided to perform evaluation of the significance by comparing the score with the score in the random data. In the case of the biological clock, it was decided to detect that the expression of gene group having a gene expression regulatory sequence periodically changes by cosine fitting and that each gene constituting the gene group has a similar change pattern with a standard deviation.

In order to perform cosine fitting, the correlation (correlation coefficient) with a cosine curve generated by shifting the time is calculated, and the highest correlation coefficient is used as a score. Due to this, in the case where the gene group has a similar expression change pattern, the standard deviation of the sum of the values for the gene group becomes large.

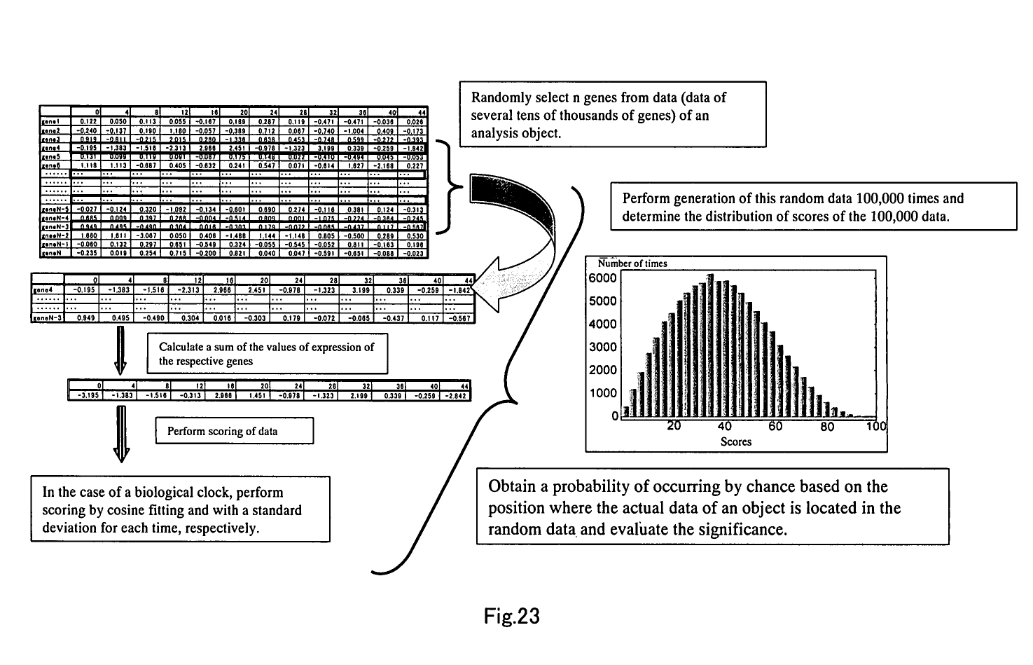

FIG. 23 shows a data structure diagram and a graph for illustrating generation of random data in the significance judgment unit 148. In this case, in order to evaluate significance, data of randomly combining genes as shown in the drawing was generated and the significance was evaluated by comparing it with the random data.

More specifically, in the case where the number of genes having a certain gene expression regulatory sequence is n, comparison with data of a random combination of n genes is performed. Then, generation of random data for the random combination of n genes was performed 100,000 times. Alternatively, in the case where the number of genes (n) to be combined is 1 to 500, the respective random data were generated.

That is, n genes were randomly selected from the data (data of several tens of thousands of genes) to be analyzed, and a sum of the values of expression of the respective genes was calculated. Further, scoring of the data was performed. In the case of a biological clock, scoring was performed by cosine fitting and with a standard deviation for each time, respectively.

At this time, the generation of the random data was performed 100,000 times, and the distribution of the scores of the 100,000 data was determined. Further, it was decided that a probability of occurring by chance was calculated based on the position where the actual data of an object was located in the random data, and evaluation of the significance was performed.

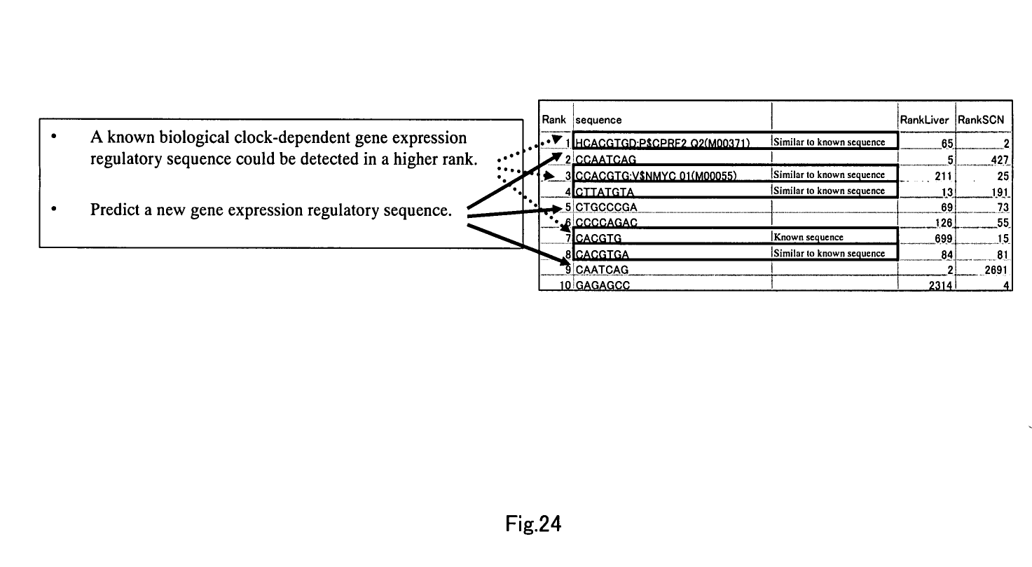

FIG. 24 is a data structure diagram for illustrating a judgment result in the significance judgment unit 148. In this case, as a method of judging significance, a correlation coefficient with a cosine curve and a standard deviation were calculated and a sequence that regulates biological clock-dependent gene expression was predicted by comparing with the random data.

As a result, a known biological clock-dependent gene expression regulatory sequence candidate could be detected in a higher rank. In addition, a new gene expression regulatory sequence candidate could be predicted. Therefore, it is expected that according to this method, the elucidation of the regulation mechanism of a biological clock can be made useful for a seed for developing a therapeutic agent for a disease involved in a biological clock disorder.

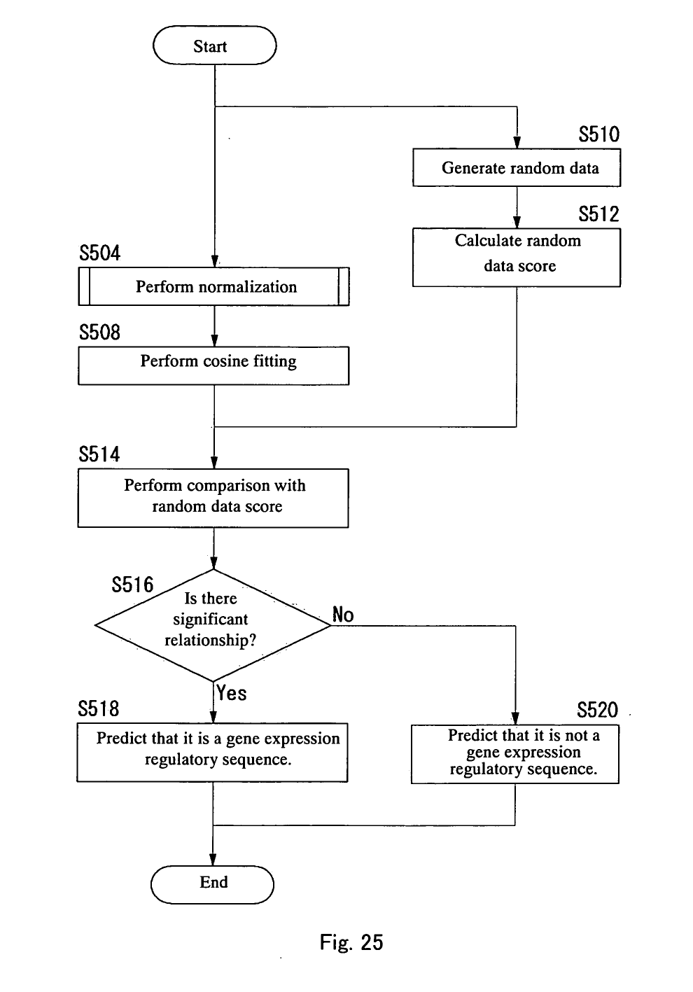

FIG. 25 is a flowchart for illustrating an operation performed by the significance judgment unit 148. This flowchart corresponds to a subroutine of the step 110 in FIG. 2.

In the significance judgment unit 148, when a series of operation is started, first, the gene expression regulatory sequence/biological phenomenon data acceptance unit 402 acquires gene expression regulatory sequence/biological phenomenon data (tertiary matrix data) from the gene expression regulatory sequence/biological phenomenon data storage unit 144. Then, the gene expression regulatory sequence/biological phenomenon data acceptance unit 402 sends the acquired gene expression regulatory sequence/biological phenomenon data to the normalization unit 406.

Then, when acquiring the gene expression regulatory sequence/biological phenomenon data, the normalization unit 406 performs normalization of the gene expression regulatory sequence/biological phenomenon data (S504). Then, the normalization unit 406 stores the normalized gene expression regulatory sequence/biological phenomenon data in the normalized data storage unit 408.

Subsequently, the cosine fitting score calculation unit 410 acquires the normalized gene expression regulatory sequence/biological phenomenon data from the normalized data storage unit 408, performs fitting of the gene expression regulatory sequence/biological phenomenon data to a cosine function and calculates a cosine fitting score (S508). Then, the cosine fitting score calculation unit 410 stores the cosine fitting score obtained by the calculation in the cosine fitting score storage unit 412.

On the other hand, the random data generation unit 414 randomly extracts part of data included in the gene expression regulatory sequence/biological phenomenon data from the gene expression regulatory sequence/biological phenomenon data storage unit 144 in accordance with the above-mentioned protocol and generates random data (S510). Then, the random data generation unit 414 stores the generated random data in the random data storage unit 416.

Subsequently, the random data score calculation unit 418 acquires the random data from the random data storage unit 416 and calculates a random data score by performing the same processing as that applied to the gene expression regulatory sequence/biological phenomenon data in accordance with the above-mentioned protocol (S512). Then, the random data score calculation unit 418 stores the random data score obtained by the calculation in the random data score storage unit 420.

Then, the reference/judgment unit 422 acquires information derived from the gene expression regulatory sequence/biological phenomenon data from the cosine fitting score storage unit 412 and the random data score from the random data score storage unit 420, and compares the information derived from the gene expression regulatory sequence/biological phenomenon data with the random data score (S514). Then, the reference/judgment unit 422 judges whether or not each of the information derived from the gene expression regulatory sequence/biological phenomenon data has a significant value to the corresponding random data score based on the comparison result (S516).

More specifically, the reference/judgment unit 422 predicts that if there is a significant result, the gene expression regulatory sequence candidate corresponding to the information derived from the gene expression regulatory sequence/biological phenomenon data is actually a gene expression regulatory sequence (S518). On the contrary, the reference/judgment unit 422 predicts that if there is not a significant result, the gene expression regulatory sequence candidate corresponding to the information derived from the gene expression regulatory sequence/biological phenomenon data is actually not a gene expression regulatory sequence (S520).

Then, the reference/judgment unit 422 stores the above judgment result in the significance judgment result storage unit 146, and the series of operation of the significance judgment unit 148 is completed.

Hereinafter, an advantage of the significance judgment unit 148 in this embodiment will be described.

As for the flow of the above-mentioned basic data processing, first, a method of determining the number of genes to be associated with a gene expression regulatory sequence was devised. Further, when scoring of the data of determining the number of genes with a highest significance is performed, the scoring method is changed depending on the biological phenomenon. At this time, as a merging method in the case where a plurality of data and a plurality of scores exist, when a plurality of data exist, by merging the plurality of data, the reliability of the prediction result can be made high. In addition, in the case of evaluation of significance, the significance is evaluated using the random data.

Further, in the bio-information analyzer 100, in the significance judgment function 103, as a merging method in the case where a plurality of data and a plurality of scores exist, the method can be made applicable to a case where a plurality of data involved in the same biological phenomenon exist and to a case where a plurality of scores exist for one data. In the case of a biological clock, scoring by cosine fitting and scoring with a standard deviation are made possible.

This results in generating random data for each of a plurality of data and a plurality of scores, and determining the distribution of the scores with the random data. That is, this results in obtaining significance (probability of occurring the score by chance) by comparing the score for the actual gene expression regulatory sequence with the random data. As a result, in the bio-information analyzer 100, significance judgment with a high accuracy is possible by an approach from both sides.

As a result, it is considered that the bio-information analysis system 1000 will become a technique useful for creation of a seed for elucidation of the mechanism of the causal factor of a disease and development of a drug for medical and biological researchers and pharmaceutical companies by combining genome-wide gene expression data and gene expression regulatory sequence candidate data. More specifically, it is considered that the bio-information analysis system 1000 is useful for predicting a relationship between a gene expression regulatory sequence such as an enhancer, an element or a promoter and a biological phenomenon such as development, differentiation, regeneration, biological clock, cell cycle and malignant transformation.

<Normalization of Data>

Hereinafter, the normalization process that was schematically illustrated in the above description will be illustrated in detail.

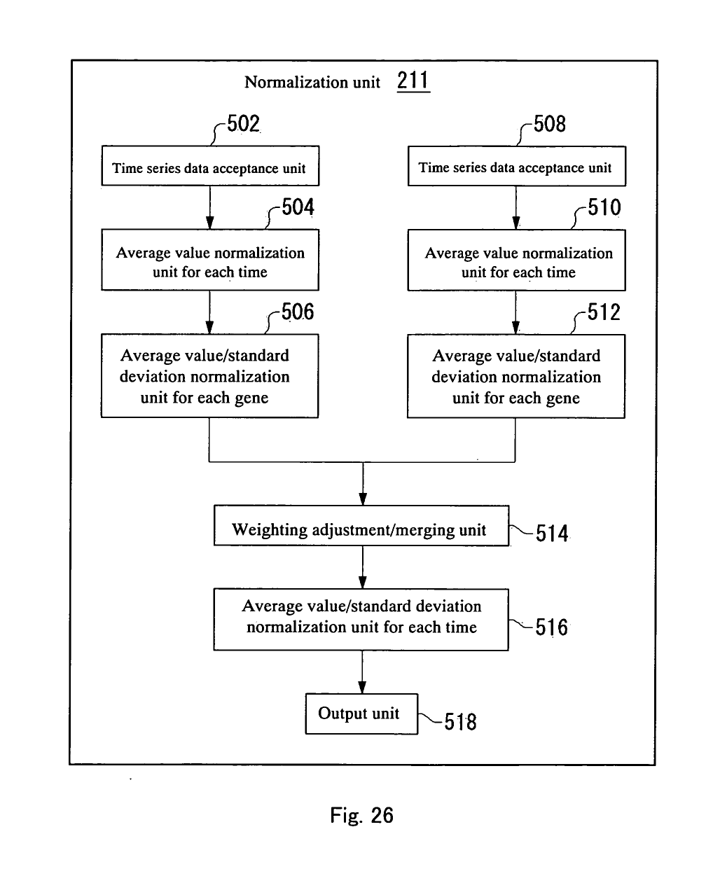

FIG. 26 is a functional block diagram showing the internal configuration of the normalization unit 211 of FIG. 2B in detail. Here, as a matter of convenience of illustration, the case of the normalization unit 211 will be described. The configuration, operation, advantage and the like of the other normalization units 406 and 915 (FIG. 20 and FIG. 17) are the same as the case of the normalization unit 211.

The normalization unit 211 is equipped with a time series data acceptance unit 502 that accepts time series data obtained in light/dark conditions, which will be described later, among data acquired from outside. The time series data acceptance unit 502 sends the time series data obtained in light/dark conditions acquired from outside to an average value normalization unit 504 for each time.

The average value normalization unit 504 normalizes the time series data obtained in light/dark conditions acquired from the time series data acceptance unit 502 in such a manner that the average value for each time becomes equal. The average value normalization unit 504 sends the data obtained by normalizing the average value for each time to an average value/standard deviation normalization unit 506 for each gene.

The average value/standard deviation normalization unit 506 for each gene normalizes the data obtained by normalizing the average value for each time acquired from the average value normalization unit 504 for each time in such a manner that for each gene, the average value becomes 0 and the standard deviation becomes 1. The average value/standard deviation normalization unit 506 for each gene sends the data obtained by normalizing the average value and the standard deviation for each gene to a weighting adjustment/merging unit 514.

On the other hand, the normalization unit 211 is equipped with a time series data acceptance unit 508 that accepts time series data obtained in constant dark conditions, which will be described later, among data acquired from outside. The time series data acceptance unit 508 sends the time series data obtained in constant dark conditions acquired from outside to an average value normalization unit 510 for each time.

The average value normalization unit 510 normalizes the time series data obtained in constant dark conditions acquired from the time series data acceptance unit 508 in such a manner that the average value for each time becomes equal. The average value normalization unit 510 sends the data obtained by normalizing the average value for each time to an average value/standard deviation normalization unit 512 for each gene.

The average value/standard deviation normalization unit 512 for each gene normalizes the data obtained by normalizing the average value for each time acquired from the average value normalization unit 510 for each time in such a manner that for each gene the average value becomes 0 and the standard deviation becomes 1. The average value/standard deviation normalization unit 512 for each gene sends the data obtained by normalizing the average value and the standard deviation for each gene to a weighting adjustment/merging unit 514.

The weighting adjustment/merging unit 514 weights the data obtained by normalizing the average value and the standard deviation (value for light/dark conditions) acquired from the average value/standard deviation normalization unit 506 for each gene and the data obtained by normalizing the average value and the standard deviation (value for constant dark conditions) acquired from the average value/standard deviation normalization unit 512 for each gene by a value of ANOVA, which will be described later, and merges the weighted value for light/dark conditions with the weighted value for constant dark conditions.

The weighting adjustment/merging unit 514 sends the value obtained by merging to an average value/standard deviation normalization unit 516 for each time. The average value/standard deviation normalization unit 516 sends the data obtained by normalizing the average value and the standard deviation for each time to an output unit 518. Then, the output unit 518 outputs the data obtained by normalizing the average value and the standard deviation for each time to outside.

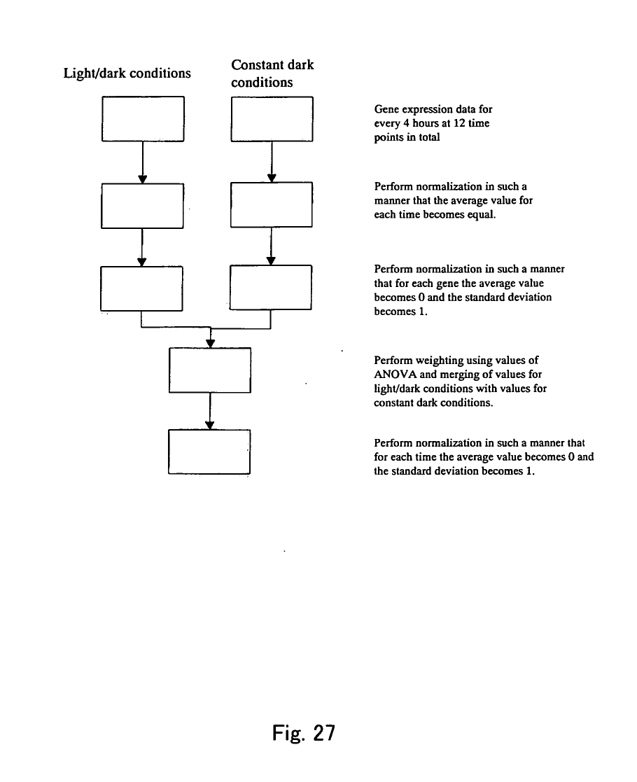

FIG. 27 is a schematic diagram for illustrating an overall flow of normalization performed by the normalization unit 211. In this case, first, normalization 1 for each time is performed. At this time, normalization is performed in such a manner that the average value of expression for each time becomes equal.

Then, as for each gene, normalization is performed for the average value and the standard deviation. It is because greater importance is attached to the wave pattern of the expression change than to the wave width or the expression intensity.

Subsequently, by using ANOVA, it is judged whether it is reproducible data based on whether the changes in expression in the light/dark conditions and the constant dark conditions are similar. At this time, weighting is performed based on the result of ANOVA and data with a higher reliability is weighted higher.

Further, normalization 2 is performed for each time. At this time, normalization is performed in such a manner that the average value and the standard deviation for each time become equal, respectively.

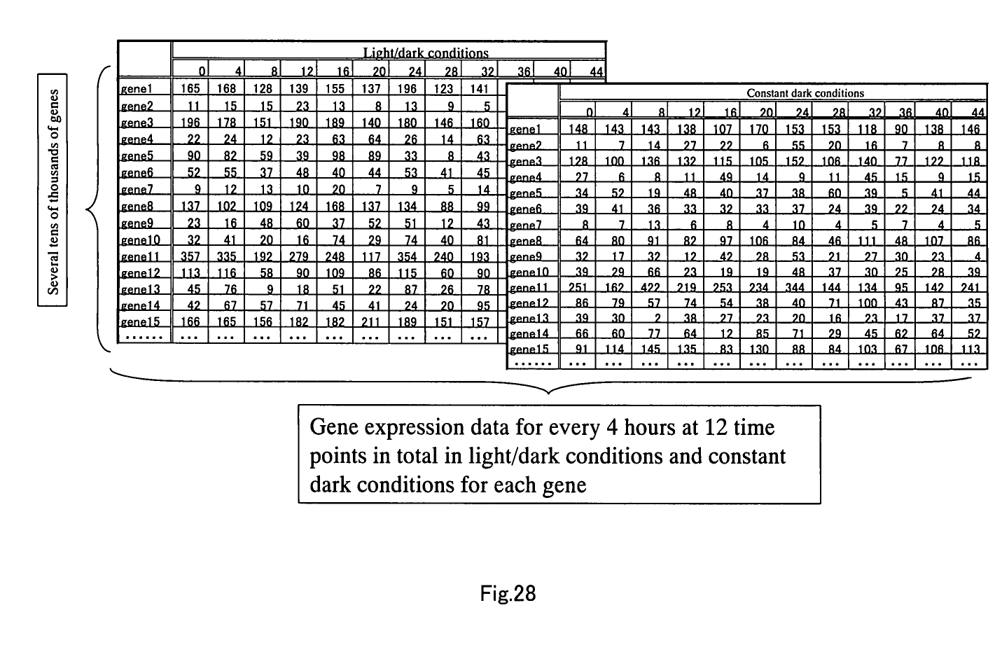

FIG. 28 is a data structure diagram for illustrating data before normalization to be input to the normalization unit 211. In this case, gene expression data for every 4 hours at 12 time points in total for the respective light/dark conditions and constant dark conditions for each of several tens of thousands of genes are used as original data.

More specifically, as original data, for mice raised in light/dark conditions (12 hour light and 12 hour dark), tissues of the mice were excised every 4 hours at 12 time points in total (0 to 44 hours) in two conditions of a: light/dark conditions per se, and b: transferring to constant dark conditions, and data obtained by measuring the expression of genes in the cells with DNA chip is used.

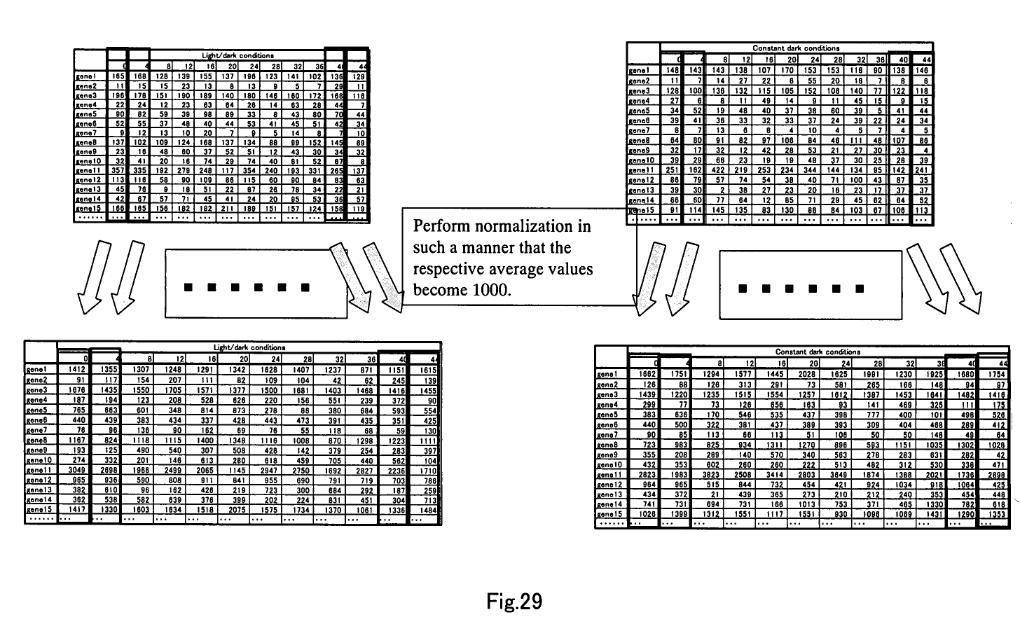

FIG. 29 is a data structure diagram for illustrating a mode of normalization of the average values for each time of the input data in FIG. 28. First, the samples processed in the manner shown in FIG. 28 are normalized in such a manner that the respective average values become 1000.

More specifically, the average values of expression of all genes to be analyzed are made equal to 1000 for each time. It is because with the use of the DNA chip, data is read at each time interval, therefore the data variation is eliminated for the respective times by this process.

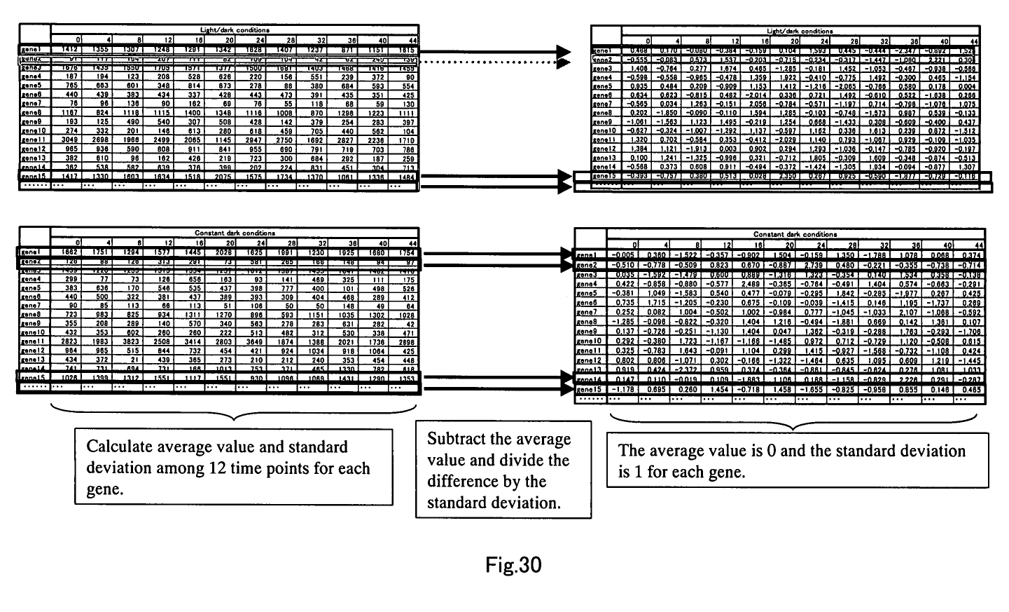

FIG. 30 is a data structure diagram for illustrating a mode of normalization of the average values and the standard deviations for each gene of the data processed in the manner shown in FIG. 29. In this case, for the samples processed in the manner shown in FIG. 29, the average value and the standard deviation among the 12 time points for each gene in the respective light/dark and constant dark conditions are calculated. Then, normalization is performed in such a manner that the average value becomes 0 and the standard deviation becomes 1 by subtracting the average value from the expression data and dividing this difference by the standard deviation.

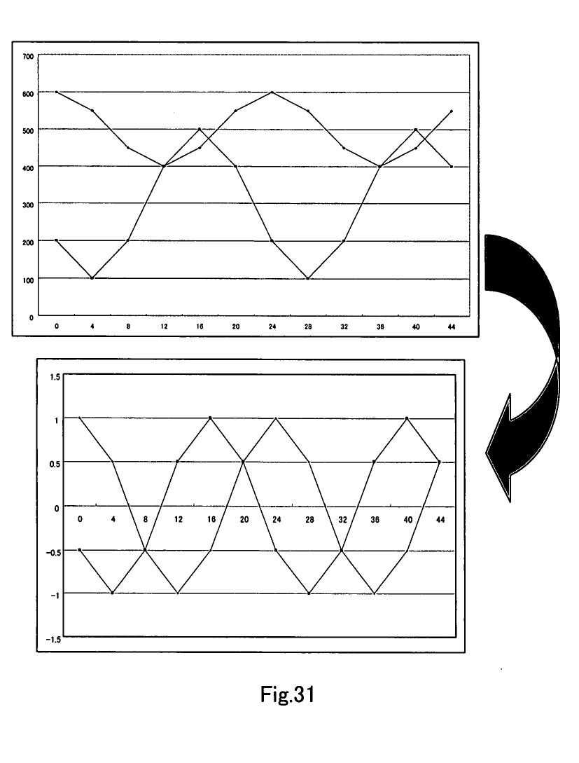

FIG. 31 shows graphs for illustrating a mode of the change of the data processed in the manner shown in FIG. 30. Here, by performing algorithm of normalization illustrated in the drawings shown up to FIG. 30, i.e., by making the average values and standard deviations equal, respectively, merging the data for the light/dark conditions with the data for the constant dark conditions and performing weighting using the values of ANOVA, it becomes possible to perform evaluation based not on the magnitude of the value of gene expression but on the wave pattern of the expression change for each gene.

At this time, by performing evaluation of a gene whose expression change is reproduced in the light/dark conditions and the constant dark conditions by performing weighting for the gene (excluding a gene whose expression change is not reproduced in both conditions), the accuracy of evaluation based on the wave pattern of expression change can be improved.

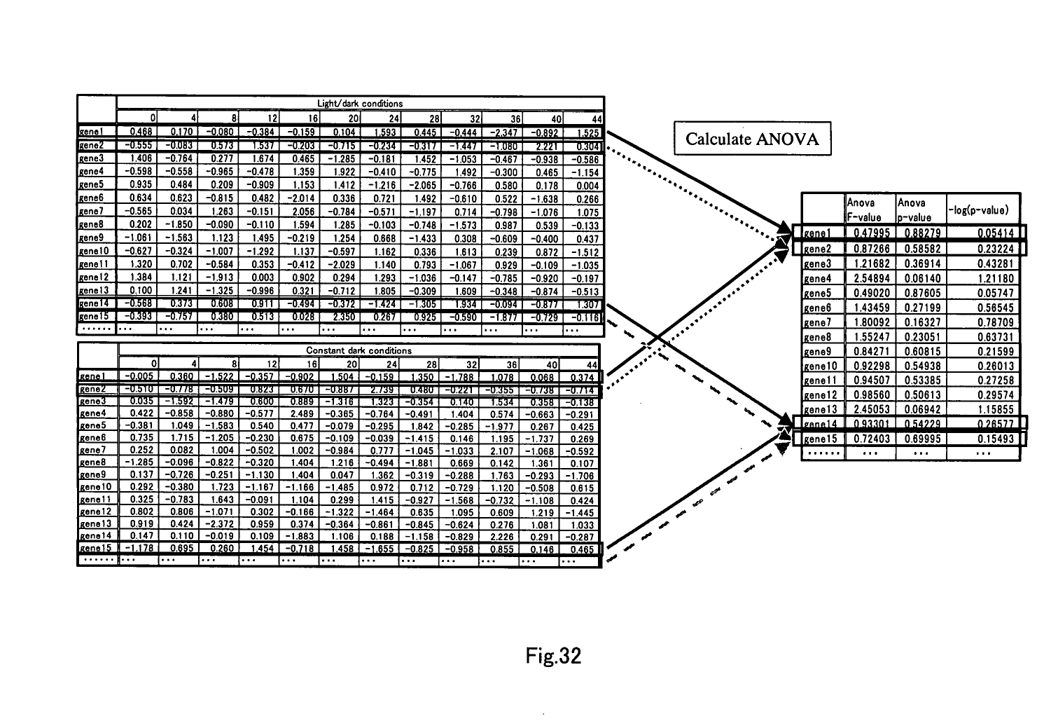

FIG. 32 is a data structure diagram for illustrating calculation of ANOVA.

Here, ANOVA is calculated for the data processed in the manner shown up to FIG. 30. More specifically, ANOVA (analysis of variance) is performed for the data for the light/dark conditions and the constant dark conditions for each gene, and F-value, p-value (probability) and −log(p-value) are calculated.

As a result, one in which a similar expression change occurs in both light/dark conditions and constant dark conditions has a low p-value. In addition, as for the one having a high p-value (about 1), changes in expression in the light/dark conditions and the constant dark conditions are different, and it can be assumed that a lot of noise is included (it is assumed that as for a gene for which the reliability of the expression data is high, the expression changes in the same manner in both light/dark conditions and constant dark conditions).

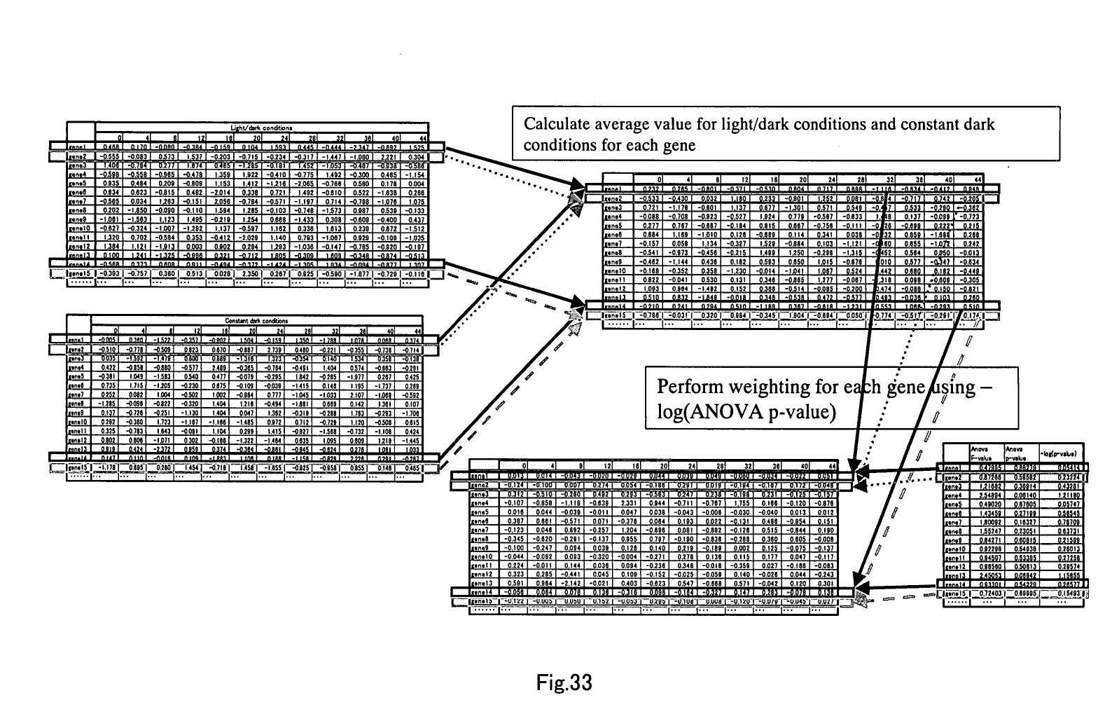

FIG. 33 is a data structure diagram for illustrating weighting/merging of the data processed in the manner shown up to FIG. 32. Here, for the data processed in the manner shown up to FIG. 32, the average values for the light/dark conditions and the constant dark conditions for each gene are calculated. Then, weighting is performed for each gene using the value of −log(ANOVA p-value).

More specifically, by calculating the average value of data for the light/dark conditions and the constant dark conditions for each gene, data are merged. Then, by multiplying the calculated average values for the light/dark conditions and the constant dark conditions by −log(ANOVA p-value), weighting is performed in such a manner that the contribution of a gene whose ANOVA p-value is low (a gene whose expression changes in the same manner in both light/dark conditions and constant dark conditions) is made large.

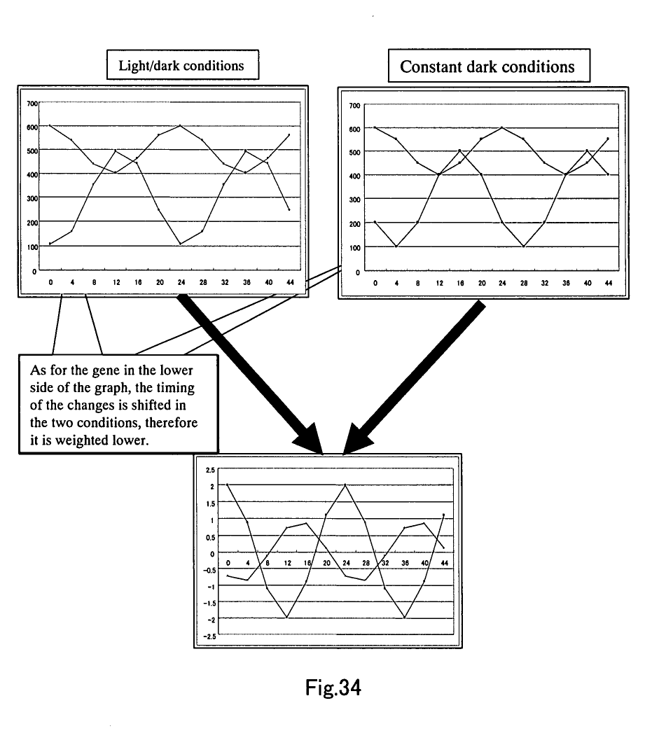

FIG. 34 shows graphs for illustrating a method of weighting in the process shown in FIG. 33. As shown in FIG. 34, when weighting is performed according to the values of ANOVA, as for a gene in the lower side of the graph, the timing of the changes is shifted in the two conditions, i.e., the light/dark conditions and the constant dark conditions, therefore, it is weighted lower.

Accordingly, by the processing of the algorithm of normalization shown up to FIG. 33, the average values and the standard deviations are made equal, respectively, data for the light/dark conditions and the data for the constant dark conditions are merged, and by performing weighting using the values of ANOVA, it becomes possible to perform evaluation based not on the magnitude of the value of gene expression but on the wave pattern of the expression change for each gene. Further, by performing evaluation of a gene whose expression change is reproduced in the light/dark conditions and the constant dark conditions by performing weighting for the gene (excluding a gene whose expression change is not reproduced in both conditions), the accuracy of the bio-information analysis system can be further improved.

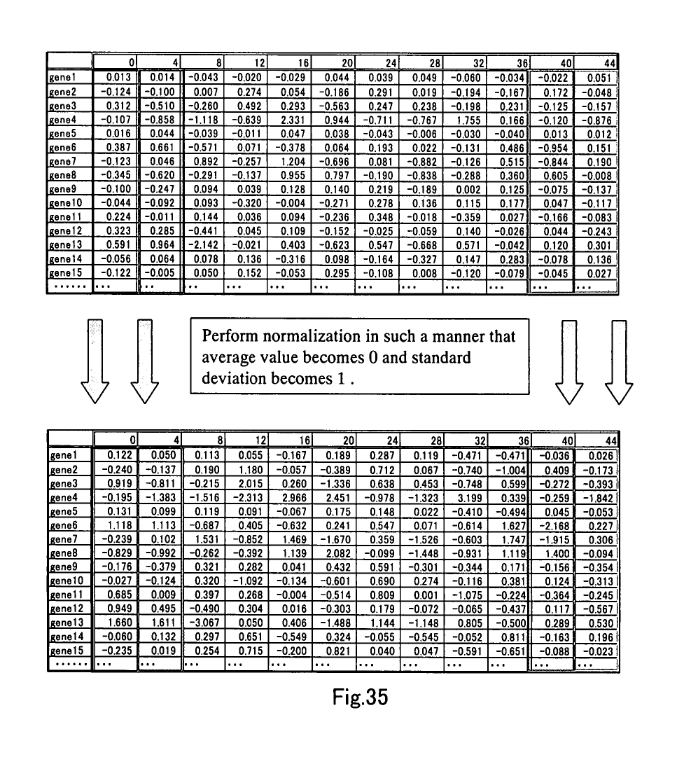

FIG. 35 is a data structure diagram for illustrating a mode of normalization of average values and standard deviations of data processed in the manner shown up to FIG. 34 for each time. Here, the data undergoing the processing shown up to FIG. 34 is further normalized in such a manner that the average value becomes 0 and the standard deviation becomes 1.

At this time, for each time, the average value and the standard deviation of the expression data of all the genes are calculated, and normalization is performed in such a manner that the average value becomes 0 and the standard deviation becomes 1 by subtracting the average value from the expression data and dividing this difference by the standard deviation, whereby the variation among the respective time intervals is corrected.

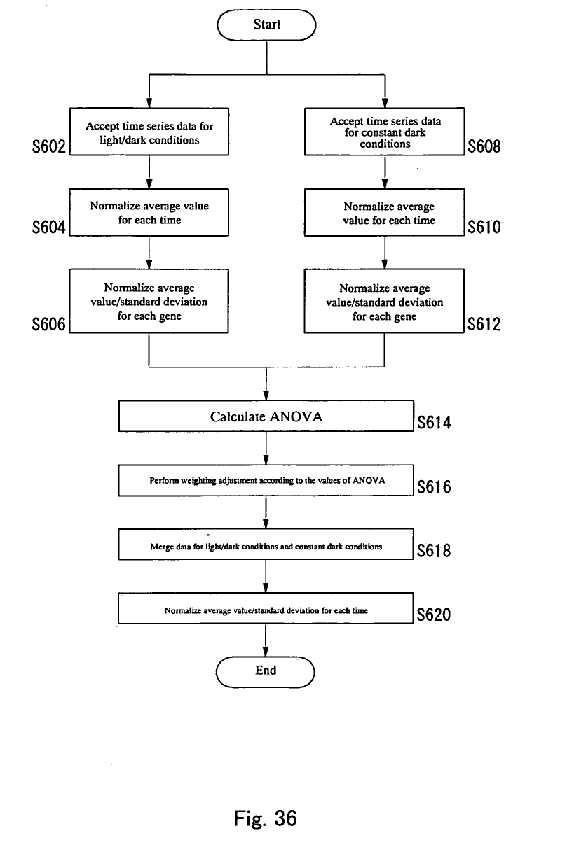

FIG. 36 is a flowchart for illustrating a mode of normalization performed by the normalization unit 211 and shows the series of flow described above by putting together. First, the time series data acceptance unit 502 accepts time series data for light/dark conditions from outside (S602) and sends the data to the average value normalization unit 504 for each time.

Then, the average value normalization unit 504 for each time normalizes the average value of the time series data for each time (S604) and sends the data to the average value/standard deviation normalization unit 506 for each gene. Subsequently, the average value/standard deviation normalization unit 506 for each gene normalizes the average value/standard deviation of the time series data for each gene (S606) and sends the data to the weighting adjustment/merging unit 514.

On the other hand, the time series data acceptance unit 508 accepts time series data for constant dark conditions from outside (S608) and sends the data to the average value normalization unit 504 for each time. Then, the average value normalization unit 510 for each time normalizes the average value of the time series data for each time (S610) and sends the data to the average value/standard deviation normalization unit 512 for each gene.

Subsequently, the average value/standard deviation normalization unit 512 for each gene normalizes the average value/standard deviation of the time series data for each gene (S612) and sends the data to the weighting adjustment/merging unit 514.

The weighting adjustment/merging unit 514 calculates the respective ANOVA for the thus obtained time series data for the light/dark conditions and the constant dark conditions (S614). Then, the weighting adjustment/merging unit 514 performs weighting adjustment according to the values of ANOVA for the time series data for the light/dark conditions and the constant dark conditions (S616). Further, the weighting adjustment/merging unit 514 merges the weighted time series data for the light/dark conditions and the constant dark conditions (S618), whereby merged time series data is obtained.

The average value/standard deviation normalization unit 516 for each time acquires the merged time series data from the weighting adjustment/merging unit 514, normalizes the average value/standard deviation of the merged time series data for each time (S620) and outputs the data to outside via the output unit 518. The flow of the series of normalization is thus completed.

As described above, in the bio-information analyzer 100, in the normalization process, the average value and the standard deviation among 12 time points are calculated for each gene and normalization of data is performed in such a manner that the average value becomes 0 and the standard deviation becomes 1 by subtracting the average value from the expression data and dividing this difference by the standard deviation. Due to this, there is an advantage that it becomes possible to perform evaluation based not on the magnitude of the wave width of the data or the intensity of expression but on the wave pattern of the expression change.

That is, in the bio-information analysis system 1000 according to this embodiment, since such a precise normalization process is performed, by making the average values and standard deviations equal, respectively, merging the data for the light/dark conditions and the data for the constant dark conditions and performing weighting using the values of ANOVA, it becomes possible to perform evaluation based not on the magnitude of the value of gene expression but on the wave pattern of the expression change for each gene. Further, by performing evaluation of a gene whose expression change is reproduced in the light/dark conditions and the constant dark conditions by performing weighting for the gene (excluding a gene whose expression change is not reproduced in both conditions), the accuracy of the bio-information analysis system can be further improved. Therefore, the accuracy of the prediction of a gene expression regulatory sequence related to a given biological phenomenon predicted using the thus obtained data is also improved.

(B) Elucidation of Regulation Mechanism of Cancer Gene

Next, as another example of significance judgment, a method of analyzing a regulation mechanism of a cancer gene will be explained. Also in the present embodiment, a similar system to the bio-information analysis system 1000 to be used for predicting a biological clock-dependent gene expression regulatory sequence can be preferably used. At this time, when it is necessary to perform normalization, different normalization from that of the above-mentioned embodiment for a biological clock is performed.

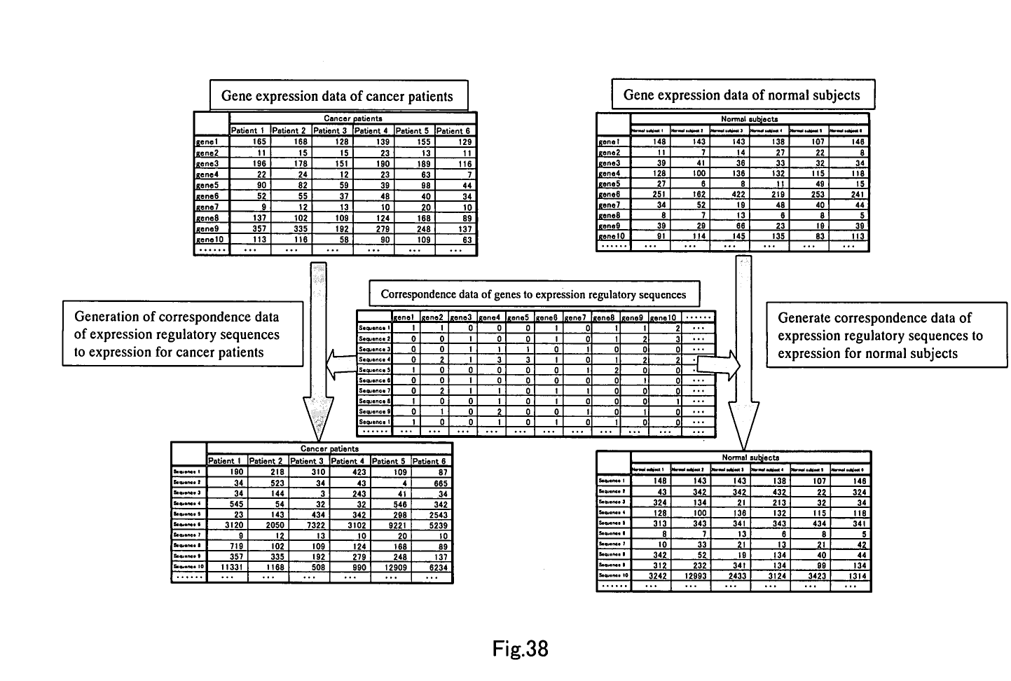

FIG. 38 is a data structure diagram for illustrating a method of analyzing a regulation mechanism of a cancer gene according to the embodiment. First, by using a similar system to the bio-information analysis system 1000, analysis for a specific tissue (for example, liver) is performed by acquiring gene expression data with DNA chips for cells obtained from cancer patients and normal subjects.

After acquiring the above data, from the gene expression data of the cancer patients and the correspondence data of genes to expression regulatory sequences, correspondence data of the expression regulatory sequences to expression for cancer patients is generated. Further, from the gene expression data of the normal subjects and correspondence data of genes to expression regulatory sequences, correspondence data of the expression regulatory sequences to expression for normal subjects is generated.

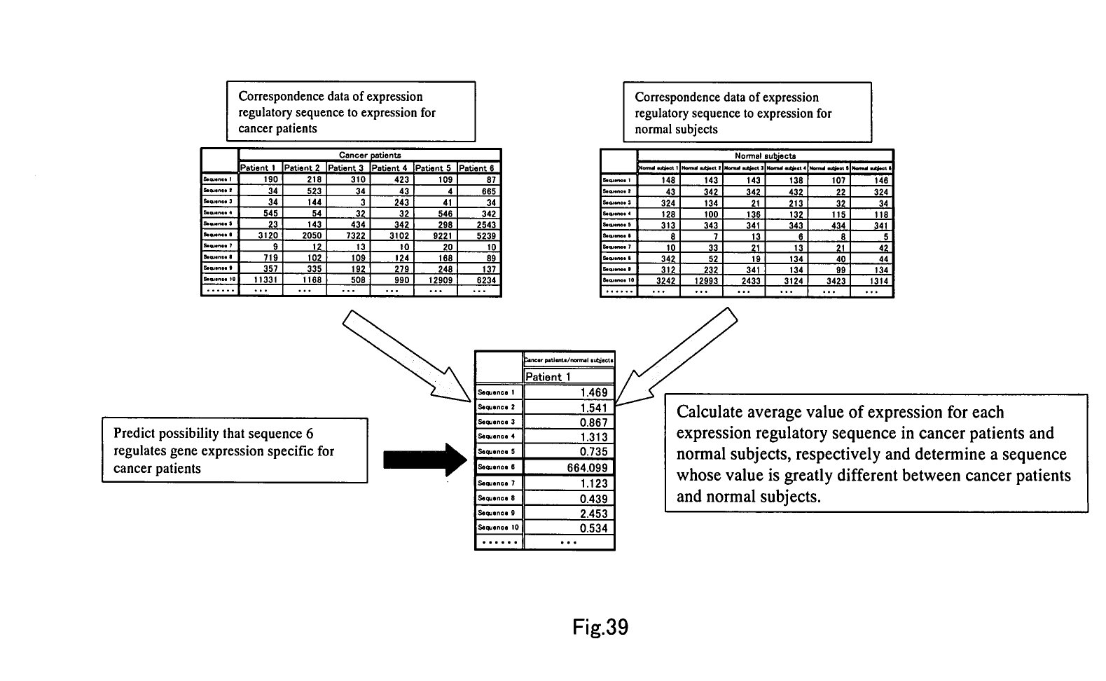

FIG. 39 is a data structure diagram for illustrating a method of analyzing a regulation mechanism of a cancer gene according to the embodiment. Here, from the correspondence data of expression regulatory sequences to expression for cancer patients and the correspondence data of expression regulatory sequences to expression for normal subjects obtained from the process shown in FIG. 38, average values of expression for each expression regulatory sequence is obtained for the cancer patients and the normal subjects, respectively, and a sequence whose value is significantly different between the cancer patients and the normal subjects is determined. For example, in this model data, the value of the sequence 6 is greatly different, therefore, it is predicted that the sequence 6 may regulate gene expression specific for cancer patients.

As described above, according to this embodiment, by elucidating a cancer-specific expression regulatory sequence, the expression regulation mechanism of a cancer gene is elucidated, which can be made useful for a seed for developing a therapeutic agent for cancer. In addition, instead of using random data, by comparing a plurality of gene expression regulatory sequence/biological phenomenon data, a gene expression regulatory sequence specific for a disease such as cancer can be predicted with high accuracy.

(C) Elucidation of Difference in Gene Regulation for Each Tissue

Next, as still another example of significance judgment, a method of analyzing a difference in gene regulation for each tissue will be explained. Also in this embodiment, a similar system to the bio-information analysis system 1000 to be used for predicting a biological clock-dependent gene expression regulatory sequence can be preferably used. At this time, when it is necessary to perform normalization, different normalization from that of the above-mentioned embodiment for a biological clock is performed.

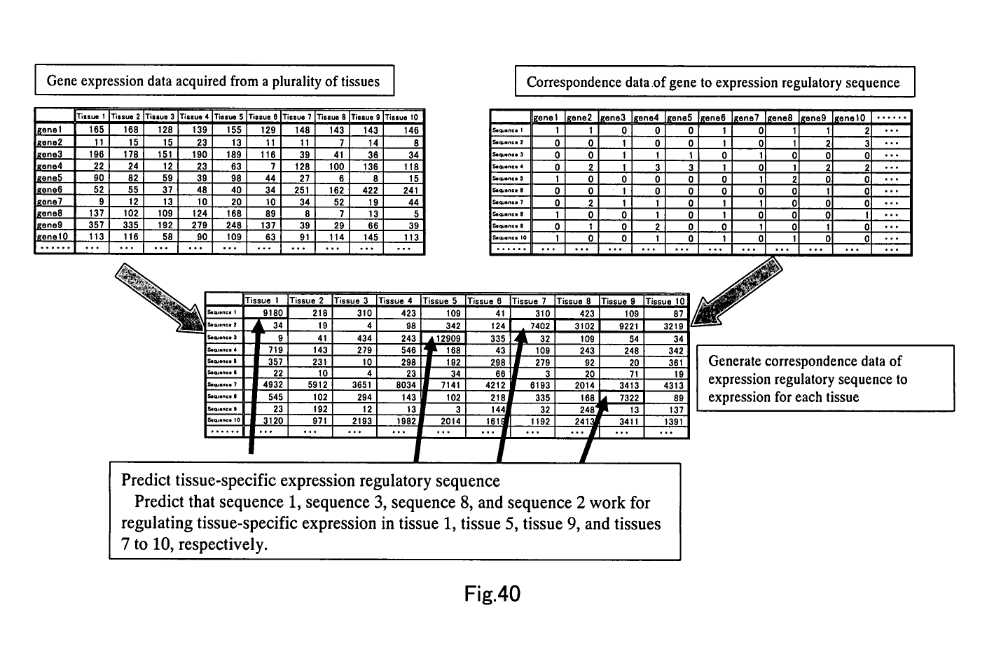

FIG. 40 is a data structure diagram for illustrating a method of analyzing a difference in gene regulation for each tissue according to the embodiment. First, by using a similar system to the bio-information analysis system 1000, analysis is performed by acquiring gene expression data for cells obtained from a plurality of tissues with DNA chip. More specifically, from gene expression data acquired from a plurality of tissues and correspondence data of genes to expression regulatory sequences, correspondence data of expression regulatory sequences to expression for each tissue is generated.

Then, by using the correspondence data of expression regulatory sequences to expression for each tissue, a tissue-specific expression regulatory sequence is predicted. For example, according to the model data shown in FIG. 40, it can be predicted that the sequence 1, sequence 3, sequence 8, sequence 2 work for regulating tissue-specific expression in the tissue 1, tissue 5, tissue 9, and tissues 7 to 10, respectively. In this way, it is expected that the elucidation of a tissue-specific expression regulatory sequence can be made useful for developing a drug that acts on a tissue in a specific manner.

Further, by analyzing data including contributions of combinations between a plurality of gene expression regulatory sequences and biological phenomena sampled from spatially different locations instead of using time series data, a tissue-specific gene expression regulatory sequence can be predicted with high accuracy. As a result, it is expected to be made useful for developing a drug that acts on a tissue in a specific manner.

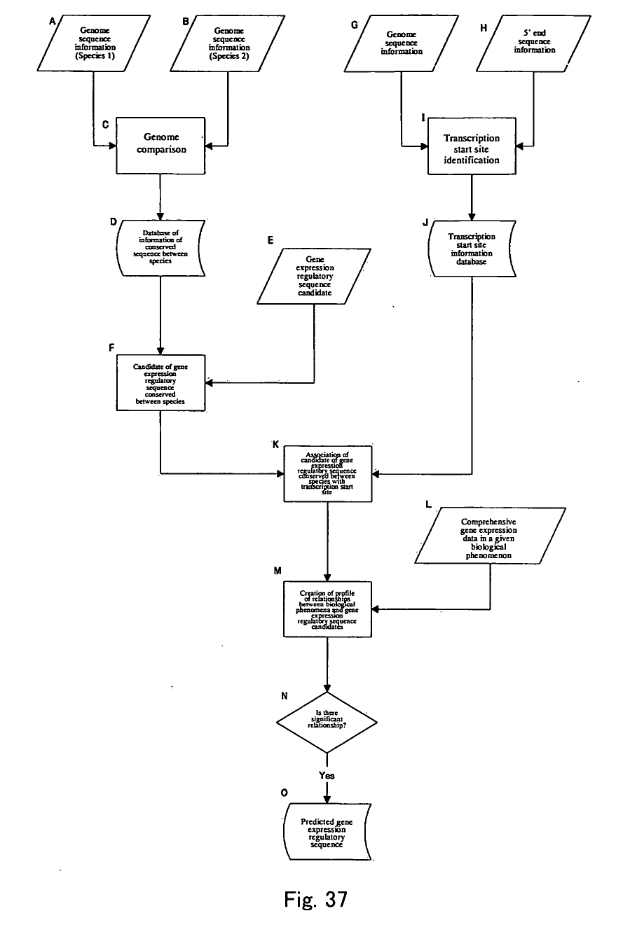

FIG. 37 is a flowchart for illustrating an overall operation performed by the bio-information analysis system according to the embodiment described above. The operational description of the process in the bio-information analysis system 1000 is shown below by summarizing again by way of FIG. 37 from a viewpoint different from the above description.

Step A: The genome sequence information of species 1 of a prediction object for a gene expression regulatory sequence is input to the bio-information analysis system 1000.

Step B: The genome sequence information of species 2 to be compared with that of the species 1 is input to the bio-information analysis system 1000.

Step C: By performing comparison analysis of the genome sequences of the species 1 and species 2, a process of identifying a genome region conserved between species is performed.

However, as for the genome sequence information of a species of a comparison object (step B) and the comparison process for genome sequences (step C), it is possible to use three or more types of species by combining the species for the genome sequence information in the step A.

Step D: A database for the information of genome regions conserved between species together with the information of conserved genome sequences is created and output.

Step E: Known and new gene expression regulatory sequence candidates are input to the bio-information analysis system 1000. As a result, it becomes possible to use a number of arbitrary sequences of about several tens of thousands types in the bio-information analysis system 1000.

Step F: As for the genome regions conserved between species obtained in the step D, a search for the gene expression regulatory sequence candidates in the step E is performed, and a process of obtaining a candidate of a gene expression regulatory sequence conserved between species is performed.

Step G: The genome sequence information of the species 1 of a prediction object for a gene expression regulatory sequence (the same as that to be input in the step A) is input to the bio-information analysis system 1000.

Step H: The 5′ end sequence information of a cDNA library in the species of the step G is input to the bio-information analysis system 1000. At this time, for comprehensively identifying transcription start sites upstream of the gene of the species, the sequence information of about several hundreds of thousands of clones is necessary as the 5′ end sequence information.

Step I: By searching the 5′ end sequence information of a gene to be input in the step H against the genome sequence information of the step G and determining the location on the genome sequence, a process of identifying the transcription start site upstream of the gene is performed.

Step J: A database of the information of the transcription start site upstream of the gene obtained in the step I together with the gene information is created and output.

Step K: The candidate of gene expression regulatory sequence conserved between species to be output in the step F is associated with the information of the transcription start site upstream of the gene in the step J, and a process of generating location-related data of the gene, transcription start site and gene expression regulatory sequence candidate is performed. That is, this step K corresponds to the step of generating and inputting the gene expression regulatory sequence/gene data (primary matrix) in the above-mentioned FIG. 3.

Step L: Comprehensive gene expression data for a number of genes typified by DNA chip is input to the bio-information analysis system 1000. At this time, comprehensive gene expression data for two or more types of samples involving a plurality of tissues, before and after administration of an active agent, a normal tissue and a disease tissue or a given biological phenomenon such as development, regeneration or biological clock time is used for input. That is, this step L corresponds to the step of generating and inputting the gene/biological phenomenon data (secondary matrix) in the above-mentioned FIG. 3.

Step M: The expression data of each gene in the step L is associated with the gene expression regulatory sequence candidate associated with the gene in the step K, and a process of creating a profile is performed by converting the contribution of each gene expression regulatory sequence candidate to comprehensive gene expression for a biological phenomenon to be an object into a numerical value. That is, this step M corresponds to the step of generating and inputting the gene expression regulatory sequence/biological phenomenon data (tertiary matrix) in the above-mentioned FIG. 3.

Step N: By performing a test for a relationship with a biological phenomenon to be an object is performed for each gene expression regulatory sequence candidate whose profile has been created in the step M, significance is determined.

Step O: A gene expression regulatory sequence candidate which has a significant relationship with the biological phenomenon to be an object in the step N is output as a predicted gene expression regulatory sequence specific for the biological phenomenon.

As described above, the bio-information analysis system 1000 is composed of two basic skeletons described below, and by combining these elemental techniques, a gene expression regulatory sequence can be efficiently predicted.

That is, the bio-information analysis system 1000 has two basic skeletons: one is creation of a database of transcription start site information and the other is prediction of a biological phenomenon-specific gene expression regulatory sequence using a database and gene expression data (i.e., by using a database of genome-wide gene expression regulatory sequence candidates and gene expression data, a biological phenomenon-specific gene expression regulatory sequence can be predicted).

Hereinafter, an advantage which can be achieved by the embodiment will be described.

According to the embodiment, as described above, correspondence data of gene expression regulatory sequences to time/space by combining two types of data, i.e., a database of genome-wide gene expression regulatory sequence candidates (correspondence data of transcription start sites to gene expression regulatory sequence candidates) and genome-wide gene expression data (correspondence data of gene expression to time/space/biological phenomenon) and a gene expression regulatory sequence specific for time/space can be predicted.

On the other hand, in a related known gene expression analysis method, a lower eukaryote such as yeast or a prokaryote was used as an analysis object. Since many of the genes of such as yeast do not contain intron, it is relatively easy to be able to identify a transcription start site. On the contrary, since it was difficult to perform comprehensive identification of transcription start sites of a gene for a higher eukaryote such as a vertebrate to date, it was difficult to predict a gene expression regulatory sequence in the vicinity of the transcription start site.

Further, since a gene expression regulatory sequence is located relatively near the upstream of the transcription start site in such as yeast, search space for gene expression regulatory sequences is small. However, in a higher eukaryote such as a vertebrate, a gene expression regulatory sequence is also located several tens-fold farther away from the transcription start site compared with the case of yeast. Due to this, for a higher eukaryote, search space for gene expression regulatory sequences in the genome is large, therefore, it was difficult to predict a gene expression regulatory sequence by a related known gene expression analysis method.

For example, even with a related known technique, a gene expression regulatory sequence can be predicted to a certain degree in yeast by a program with the use of gene expression data. It is because identification of a transcription start site in yeast is easy. The reason is that a gene expression regulatory sequence of yeast is located in the vicinity of a transcription start site (within about 1000 nucleotides).

A gene expression regulatory sequence of a human gene is composed of about several nucleotides against about 3 billion nucleotides of the human genome, however, the gene expression regulatory sequence is located in the vicinity of the gene (mainly in the upstream). Further, the gene expression regulatory sequence of a human gene is sometimes located several thousands to several tens of thousands of nucleotides away from the transcription start site of the gene. Due to this, it was difficult to identify the transcription start site of the gene.

Further, in either yeast or human for example, there are some gene expression regulatory sequences which have the same sequence but some of which work for regulating expression but the others do not. Even for the same genes, their expression is regulated in various ways according to various biological phenomena. Further, there is a case where one gene has a plurality of gene expression regulatory sequences. Therefore, even for known gene expression regulatory sequences, many of the biological phenomena related to the sequences remain unrevealed.

Due to the addition of these factors, it was difficult to detect changes in expression of genes by changing a nucleotide sequence in the vicinity of a gene by an experiment and to identify gene expression regulatory sequences for several tens of thousands of genes only by experiments with the use of a related known identification method for gene expression regulatory sequences. Therefore, prediction and identification of gene expression regulatory sequences by a program have not been achieved for a vertebrate.

However, in the bio-information analyzer 100 according the embodiment, a profile of gene expression regulatory sequence information is created, therefore the above problems have been solved. That is, in the bio-information analyzer 100, what is performed is not the prediction of a common sequence from a specific gene group whose expression specific for a biological phenomenon changes, but the creation of a profile of a relationship between a biological phenomenon and a sequence candidate by using comprehensive gene expression information in a given biological phenomenon for a given sequence candidate of a known/new gene expression regulatory sequence.

In the bio-information analyzer 100, by creating a profile of a number of sequence candidates as described above, a sequence with a higher relationship with a biological phenomenon is predicted as a gene expression regulatory sequence, therefore, it becomes easy to predict also a gene expression regulatory sequence that was difficult to be searched as a common sequence among a gene group by a related art.

That is, the bio-information analyzer 100 uses gene expression regulatory sequence candidate information which is generated with the above-mentioned information of candidates of gene expression regulatory sequences conserved between species and transcription start site information data and is associated with gene transcription start site information. In addition, the bio-information analyzer 100 uses information of candidates of gene expression regulatory sequences conserved between species generated with data of conserved sequence between species and gene expression regulatory sequence candidates. Further, the bio-information analyzer 100 is configured so as to verify a statistical significance of a relationship between a biological phenomenon and a gene expression regulatory sequence candidate whose profile has been created using the above data and to output a predicted gene expression regulatory sequence for a gene expression regulatory sequence candidate whose significance has been verified.

As described above, the bio-information analyzer 100 uses a technique of converting the degree of a relationship of a biological phenomenon from which used gene expression data has been collected to gene expression into a numerical value (creation of a profile of a relationship between a biological phenomenon and a gene expression regulatory sequence candidate) for each gene expression regulatory sequence candidate obtained from the expression intensity of a gene having a gene expression regulatory sequence candidate in the vicinity thereof by combining the above-mentioned gene expression regulatory sequence candidate information associated with the gene transcription start site information with data of comprehensive gene expression in a given biological phenomenon acquired by such as a DNA chip method, whereby the problem that was difficult to be solved by the above-mentioned related art can be solved.

Therefore, as an image of practical application, the bio-information analyzer 100 can be used for system construction of a commissioned analysis that performs prediction of a biological phenomenon-specific gene transcription regulatory sequence using gene expression regulatory sequence candidate data and a large amount of gene expression data.

Hereinabove, the embodiment of the invention has been described by referring to the accompanying drawings, however, it is intended to be illustrative of the invention and various configurations other than those described above can also be adopted.

For example, in the above embodiment, a configuration in which genome sequence information of two types of species is used is adopted, however, genome sequence information of three or more types of species may be used. By doing this, an advantage that the accuracy of prediction of a gene expression regulatory sequence is further improved can be obtained.

Further, in the above embodiment, the expression level of mRNA is adopted as a biological phenomenon, however, the production level of a protein, the secretion level of a given substance or the like can also be an analysis object as a biological phenomenon. It is because such a phenomenon is considered to be regulated by a gene expression regulatory sequence.

Further, in the above embodiment, a gene encoding a protein is adopted as a gene sequence candidate (or a gene candidate sequence), however, a non-coding gene, a pseudogene or the like can also be an analysis object as a gene sequence candidate. It is because such an object is considered to be also regulated by an expression regulatory sequence.

Further, in the above embodiment, the transcription regulatory sequence is adopted as a gene expression regulatory sequence candidate, however, a translation regulatory sequence, a degradation regulatory sequence, a modification regulatory sequence and a localization regulatory sequence can also become an analysis object as a gene expression regulatory sequence candidate. It is because these regulatory sequences are considered also to regulate gene expression.

Further, in the above embodiment, the candidate of a sequence that regulates gene expression is expressed as a gene expression regulatory sequence candidate, however, it is not particularly limited to this and can also be expressed, for example, as an expression regulatory sequence candidate, an expression regulatory candidate sequence, a gene expression regulatory candidate sequence or the like.

Further, in the above embodiment, the sequence that regulates gene expression is expressed as a gene expression regulatory sequence, however, it is not limited to this and can also be expressed, for example, as an expression regulatory sequence or the like.

As described above, the biological phenomenon analyzer according to the present invention can search various gene expression regulatory sequence candidates in a wide variety of living organisms including higher eukaryotes, therefore, it is useful as a bio-information analyzer, a bio-information analysis method, a bio-information analysis program and the like.

Persons of ordinary skill in the art will realize that many modifications and variations of the above embodiments may be made without departing from the novel and advantageous features of the present invention. Accordingly, all such modifications and variations are intended to be included within the scope of the appended claims. The specification and examples are only exemplary. The following claims define the true scope and spirit of the invention.

What is claimed is:

1. A bio-information analyzer comprising:
a primary data acquisition unit which acquires primary data including regulatory-side contributions which are contributions of combinations between a gene expression regulatory sequence candidate of an analysis object and each of a plurality of gene sequence candidates;
a secondary data acquisition unit which acquires secondary data including phenomenon-side contributions which are contributions of combinations between each of the plurality of gene sequence candidates and a biological phenomenon of an analysis object;
a tertiary data generation unit which generates, based on the primary data and the secondary data, tertiary data which includes a total contribution of a combination between the gene expression regulatory sequence candidate and the biological phenomenon through the plurality of gene sequence candidates, which is a sum of individual contributions of a combination between the gene expression regulatory sequence candidate and the biological phenomenon based on the regulatory-side contributions of the primary data and the phenomenon-side contributions of the secondary data corresponding to the respective gene sequence candidates; and
an output unit which outputs the tertiary data.

2. The bio-information analyzer according to claim 1, wherein the tertiary data generation unit is configured so as to generate the tertiary data composed of a tertiary matrix whose matrix elements are contributions of combinations between each of the plurality of gene expression regulatory sequence candidates and each of the plurality of biological phenomena by calculating a product of a primary matrix based on the primary data by a secondary matrix based on the secondary data.

3. The bio-information analyzer according to claim 1, further comprising a judgment unit which judges whether there is a significant relationship among the respective combinations between the gene expression regulatory sequence candidates and the biological phenomena included in the tertiary data,
wherein the output unit outputs an analysis result based on a judgment result by the judgment unit.

4. The bio-information analyzer according to claim 1, wherein the primary data is obtained based on
the plurality of gene sequence candidates in genome sequence information of a predetermined species;
the gene expression regulatory sequence candidate in the genome sequence information; and
a plurality of transcription start sites respectively associated with the plurality of gene sequence candidates in the genome sequence information, and
the primary data further includes data generated by associating with the gene sequence candidate, the gene expression regulatory sequence candidate located within a predetermined distance from the transcription start site in the upstream of the transcription start site associated with the gene sequence candidate in the genome sequence information.

5. The bio-information analyzer according to claim 4, wherein the gene expression regulatory sequence candidate is associated with the gene sequence candidate based on a contribution according to the distance between the transcription start site and the gene expression regulatory sequence candidate.

6. The bio-information analyzer according to claim 4, wherein the gene expression regulatory sequence candidate contains a sequence whose conservation level among genome sequence information of a plurality of species is a predetermined level or higher.

7. The bio-information analyzer according to claim 4, wherein the gene expression regulatory sequence candidate contains a known gene expression regulatory sequence candidate or a gene expression regulatory sequence candidate composed of an arbitrarily generated sequence.

8. The bio-information analyzer according to claim 4, wherein the plurality of transcription start sites are obtained based on
the plurality of gene sequence candidates in the genome sequence information; and
5′ end sequences of a plurality of cDNA sequences in the genome sequence information, and
each of the plurality of transcription start sites corresponding to the plurality of 5′ end sequences is associated with each of the gene sequence candidates located downstream of the 5′ end sequences of the plurality of cDNA sequences.

9. The bio-information analyzer according to claim 1, wherein the contribution of a combination between the gene sequence candidate and the biological phenomenon is a value obtained from an expression intensity of the gene sequence candidate.

10. The bio-information analyzer according to claim 1, wherein the contribution of a combination between the gene sequence candidate and the biological phenomenon is a value obtained from an mRNA expression level of the gene sequence candidate.

11. The bio-information analyzer according to claim 1, wherein the secondary data is data obtained by a microarray assay.

12. The bio-information analyzer according to claim 1, wherein the biological phenomenon is a biological phenomenon related to a time series.

13. The bio-information analyzer according to claim 1, wherein the biological phenomenon is a biological phenomenon related to a disease.

14. The bio-information analyzer according to claim 1, wherein the biological phenomenon is a biological phenomenon related to a tissue.

15. A bio-information analysis method comprising the steps of:
acquiring primary data including regulatory-side contributions which are contributions of combinations between a gene expression regulatory sequence candidate of an analysis object and each of a plurality of gene sequence candidates;
acquiring secondary data including phenomenon-side contributions which are contributions of combinations between each of the plurality of gene sequence candidates and a biological phenomenon of an analysis object;
generating tertiary data based on the primary data and the secondary data, which includes a total contribution of a combination between the gene expression regulatory sequence candidate and the biological phenomenon through the plurality of gene sequence candidates, which is a sum of individual contributions of a combination between the gene expression regulatory sequence candidate and the biological phenomenon based on the regulatory-side contributions of the primary data and the phenomenon-side contributions of the secondary data corresponding to the respective gene sequence candidates; and
outputting the tertiary data.

16. The bio-information analysis method according to claim 15, wherein the step of generating tertiary data includes generating tertiary data composed of a tertiary matrix whose matrix elements are contributions of combinations between each of the plurality of gene expression regulatory sequence candidates and each of the plurality of biological phenomena by calculating a product of a primary matrix based on the primary data by a secondary matrix based on the secondary data.

17. A bio-information analysis program which makes a computer execute the steps of:
acquiring primary data including regulatory-side contributions which are contributions of combinations between a gene expression regulatory sequence candidate of an analysis object and each of a plurality of gene sequence candidates;
acquiring secondary data including phenomenon-side contributions which are contributions of combinations between each of the plurality of gene sequence candidates and a biological phenomenon of an analysis object;
generating tertiary data based on the primary data and the secondary data, which includes a total contribution of a combination between the gene expression regulatory sequence candidate and the biological phenomenon through the plurality of gene sequence candidates, which is a sum of individual contributions of a combination between the gene expression regulatory sequence candidate and the biological phenomenon based on the regulatory-side contributions of the primary data and the phenomenon-side contributions of the secondary data corresponding to the respective gene sequence candidates; and
outputting an analysis result based on the tertiary data.

18. The bio-information analysis program according to claim 17, wherein the step of generating tertiary data includes generating tertiary data composed of a tertiary matrix whose matrix elements are contributions of combinations between each of the plurality of gene expression regulatory sequence candidates and each of the plurality of biological phenomena by calculating a product of a primary matrix based on the primary data by a secondary matrix based on the secondary data.
